(19) United States
(12) Patent Application Publication
(10) Pub. No.: US 2009/0041531 A1
(43) Pub. Date: Feb. 12, 2009

(54) LEVER-ARCH TYPE FILE MECHANISM

(76) Inventors: Chun Yuen To, Shatin (HK); Hung Yu Cheng, Shatin (HK)

Correspondence Address: OSTROLENK FABER GERB & SOFFEN, 1180 AVENUE OF THE AMERICAS, NEW YORK, NY, 100368403, US

(21) Appl. No.: 12/032,229

(22) Filed: Feb. 15, 2008

(30) Foreign Application Priority Data
Aug. 10, 2007 (EP) 07253152.8

(51) Int. Cl. B42F 13/20

(52) U.S. Cl. 402/31

(57) ABSTRACT

A lever-arch type file mechanism is disclosed as including a base, two rings secured to and extending upwardly from the base for engaging holes in pieces of paper, each ring including a post fixed to the base and an arch movable relative to the post, and a lever assembly operable to move the arches relative to the posts between a ring-closed configuration in which the rings are closed and a ring-open configuration in which the rings are open, and a lever of the lever assembly is pivotable downwardly from a first position (J) to a second position (K) to move the rings from the ring-closed configuration to the ring-open configuration, and subsequently pivotable downwardly from the second position to a third position (L) to move the rings from the ring-open configuration to the ring-closed configuration. The lever is also pivotable upwardly to move the rings from the ring-closed configuration to the ring-open configuration. The lever is pivotable downwardly to effect a pulling force on a first point on a link to move the link to rotate in a first direction, and the lever is pivotable upwardly to effect a pushing force on a second point on the link to move the link to rotate in the same first direction. The link is releasably engageable with another link which is carried by the lever.

This invention relates to a lever-arch type file mechanism for retaining a stack of hole-punched paper, in particular such a mechanism adapted to be affixed to a substrate, e.g. a cardboard cover, to form a paper retaining device, such as a lever-arch type file.

In a conventional lever-arch type file mechanism, a one-armed lever pivotable to pivot a pair of arches relative to a pair of fixed posts to allow pieces of hole-punched paper to be retrieved from or inserted into the file mechanism, and for closing the posts and arches to form a pair of closed rings to retain the paper therein. The pair of arches are joined by an intervening crank on which a roller attached to the lever travels during pivotal movement of the lever, to effect opening or closing of the ring pairs. In operating such a conventional file mechanism, the lever is pivoted downwardly to close the ring pairs formed by the posts and arches and pivoted upwardly to open the rings.

Such a conventional file mechanism is not convenient in use, in that the lever has to be moved in different directions to effect opening and subsequent closing of the rings, and the rings may only be opened by moving the lever from its ring-closed position in one single direction.

It is thus an object of the present invention to provide a lever-arch type file mechanism and a paper retaining device with such a mechanism in which the aforesaid shortcoming is mitigated, or at least to provide a useful alternative to the trade and public.

According to a first aspect of the present invention, there is provided a lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; characterized in that a lever member of said lever assembly is pivotable in a first direction from a first position to a second position to move said rings from said ring-closed configuration to said ring-open configuration, and subsequently pivotable in said first direction from said second position to a third position to move said rings from said ring-open configuration to said ring-closed configuration.

According to a second aspect of the present invention, there is provided a lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; wherein a lever member of said lever assembly is pivotable in a first direction to move said rings from said ring-closed configuration to said ring-open configuration; characterized in that said lever member is pivotable in an opposite second direction to move said rings from said ring-closed configuration to said ring-open configuration.

According to a third aspect of the present invention, there is provided a lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; wherein said lever assembly includes a lever member and a first link member connected directly or indirectly with each other; wherein said first link member carries a roller member movable on and along a crank portion joining said arch members; and wherein said first link member is rotatable about an axis from a first position to a second position to allow said rings to move from said ring-closed configuration to said ring-open configuration; characterized in that said lever member is pivotable in a first direction to effect a force on a first point on said first link member between said axis and said base to move said first link member from said first position to said second position, and said lever member is pivotable in an opposite second direction to effect a force on a second point on said first link member which is away from said axis and said base to move said link member from said first position to said second position.

According to a fourth aspect of the present invention, there is provided a lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; wherein said lever assembly includes at least a lever member, a first link member and a second link member; characterized in that said lever member carries said first link member, and said first link member is releasably engageable with said second link member.

According to a fifth aspect of the present invention, there is provided a paper retaining device including a lever-arch type file mechanism, said lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; characterized in that a lever member of said lever assembly is pivotable in a first direction from a first position to a second position to move said rings from said ring-closed configuration to said ring-open configuration, and subsequently pivotable in said first direction from said second position to a third position to move said rings from said ring-open configuration to said ring-closed configuration.

According to a sixth aspect of the present invention, there is provided a paper retaining device including a lever-arch type file mechanism, said lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; wherein a lever member of said lever assembly is pivotable in a first direction to move said rings from said ring-closed configuration to said ring-open configuration; characterized in that said lever member is pivotable in an opposite second direction to move said rings from said ring-closed configuration to said ring-open configuration.

According to a seventh aspect of the present invention, there is provided a paper retaining device including a lever-arch type file mechanism, said lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; wherein said lever assembly includes a lever member and a first link member connected directly or indirectly with each other; wherein said first link member carries a roller member movable on and along a crank portion joining said arch members; and wherein said first link member is rotatable about an axis from a first position to a second position to allow said rings to move from said ring-closed configuration to said ring-open configuration; characterized in that said lever member is pivotable in a first direction to effect a force on a first point on said first link member between said axis and said base to move said first link member from said first position to said second position, and said lever member is pivotable in an opposite second direction to effect a force on a second point on said first link member which is away from said axis and said base to move said link member from said first position to said second position.

According to an eighth aspect of the present invention, there is provided a paper retaining device including a lever-arch type file mechanism, said lever-arch type file mechanism including a base; at least two rings secured to and extending upwardly from the base for engaging holes in at least a piece of paper, each said ring including a post member fixed to said base and an arch member movable relative to said post member; and a lever assembly operable to move said arch members relative to said post members between a ring-closed configuration in which said rings are closed and a ring-open configuration in which said rings are open; wherein said lever assembly includes at least a lever member, a first link member and a second link member; characterized in that said lever member carries said first link member, and said first link member is releasably engageable with said second link member.

Embodiments of the present invention will now be described, by way of examples only, with reference to the accompanying drawings, in which:

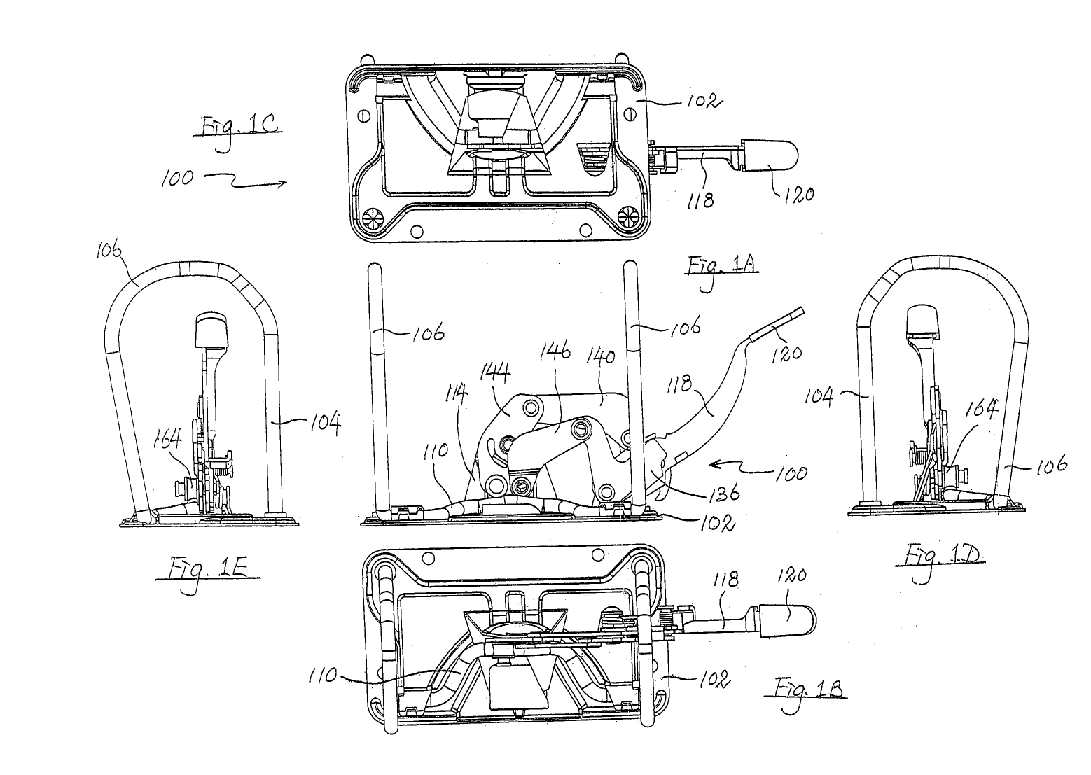

FIG. 1A is a front view of a lever-arch type file mechanism according to a first embodiment of the present invention, in a ring-closed configuration;

FIG. 1B is a top view of the mechanism shown in FIG. 1A;

FIG. 1C is a bottom view of the mechanism shown in FIG. 1A;

FIG. 1D is a left side view of the mechanism shown in FIG. 1A;

FIG. 1E is a right side view of the mechanism shown in FIG. 1A;

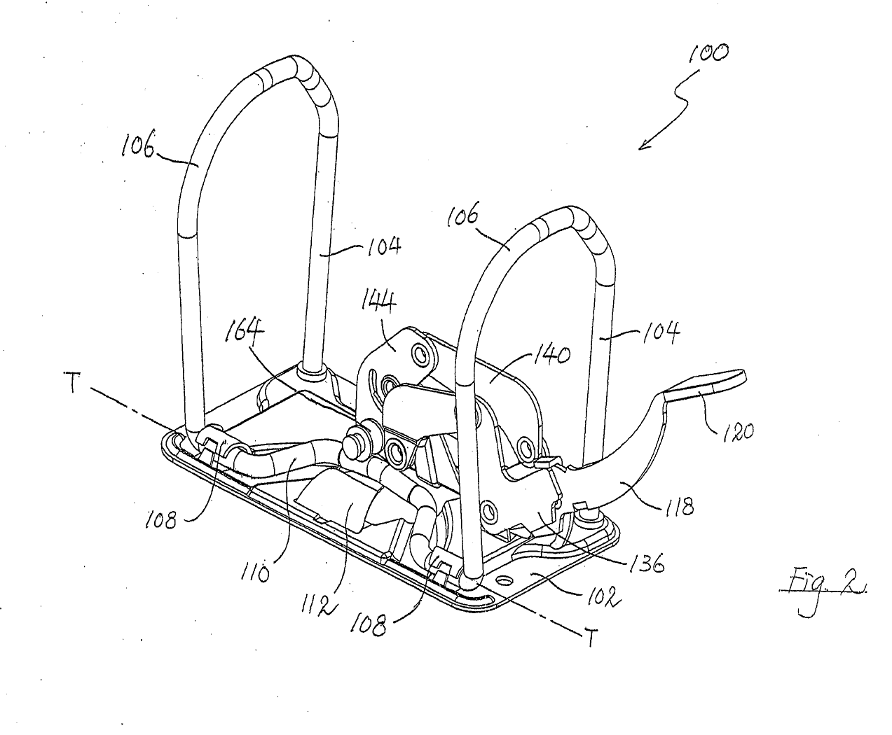

FIG. 2 is a front top perspective view of the mechanism shown in FIG. 1A;

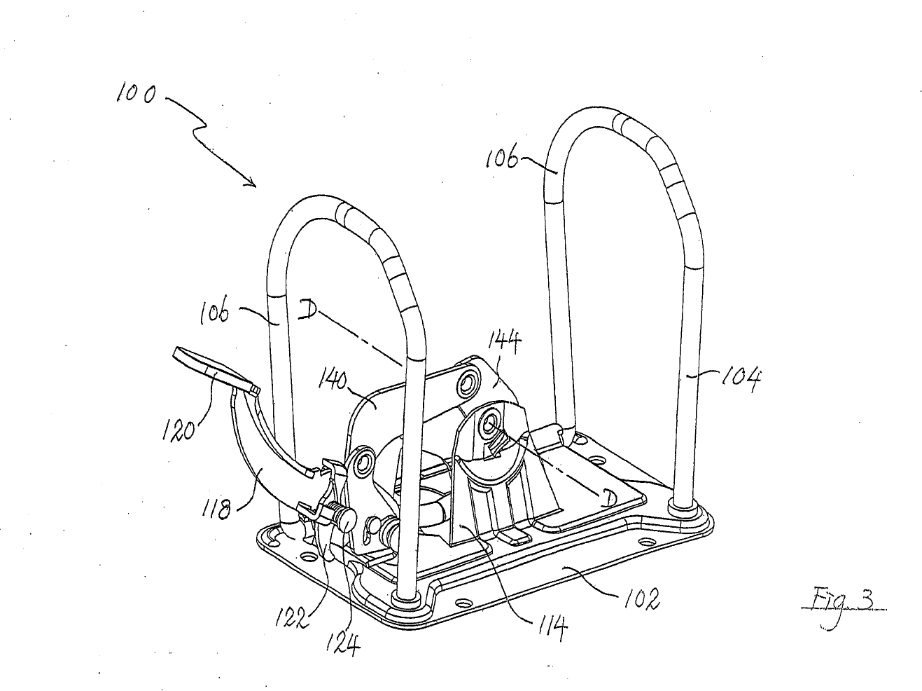

FIG. 3 is a rear top perspective view of the mechanism shown in FIG. 1A;

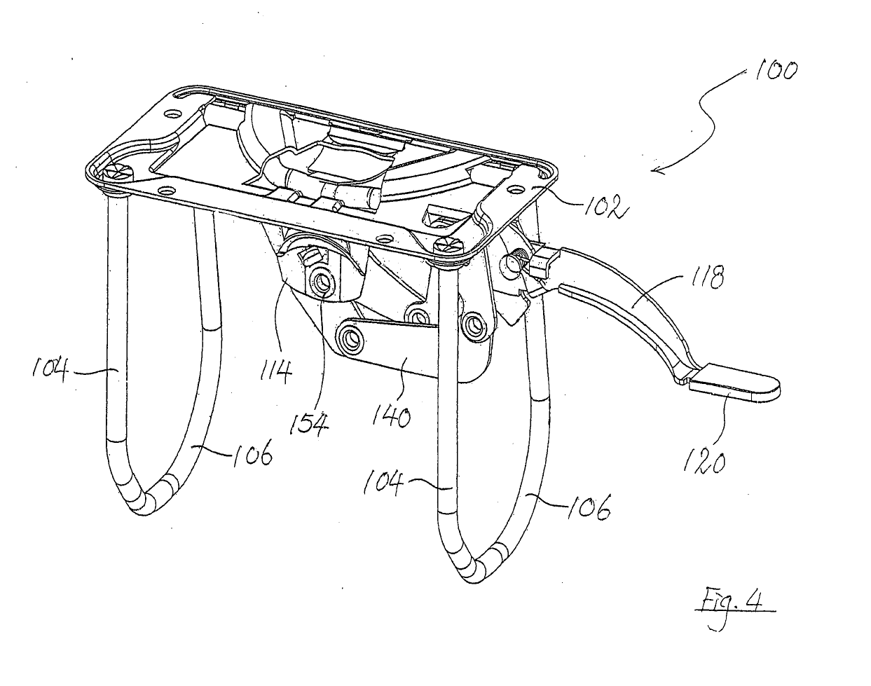

FIG. 4 is a rear bottom perspective view of the mechanism shown in FIG. 1A;

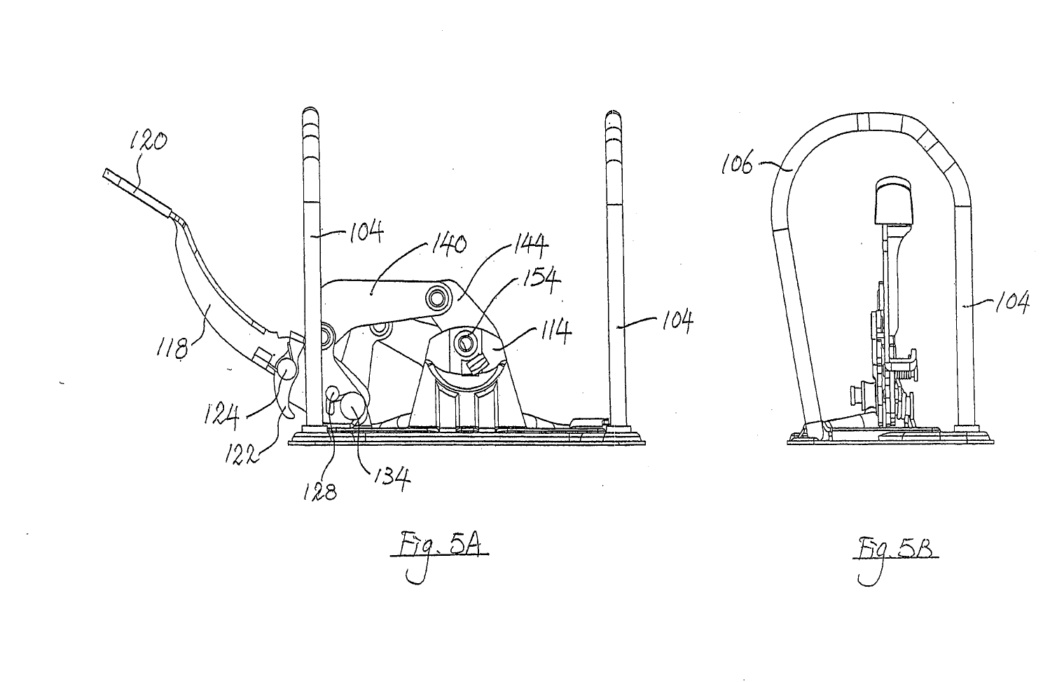

FIG. 5A is a rear view of the mechanism shown in FIG. 1A;

FIG. 5B is a left side view of the mechanism shown in FIG. 5A;

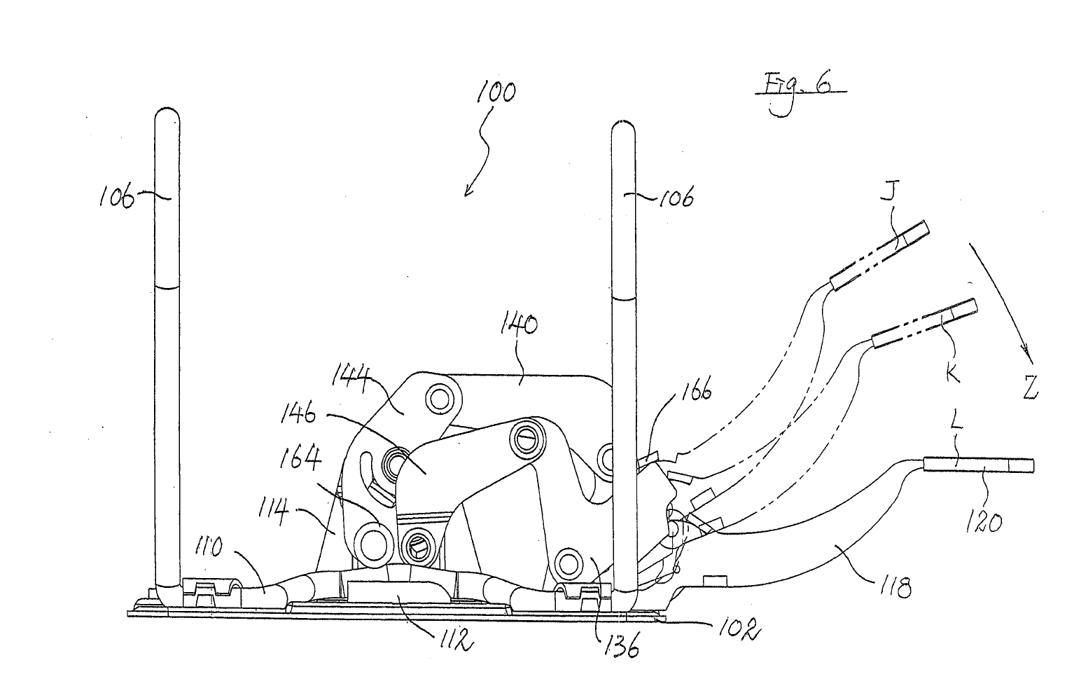

FIG. 6 is a front view of the mechanism shown in FIG. 1A showing a number of positions in which the lever of the mechanism may occupy;

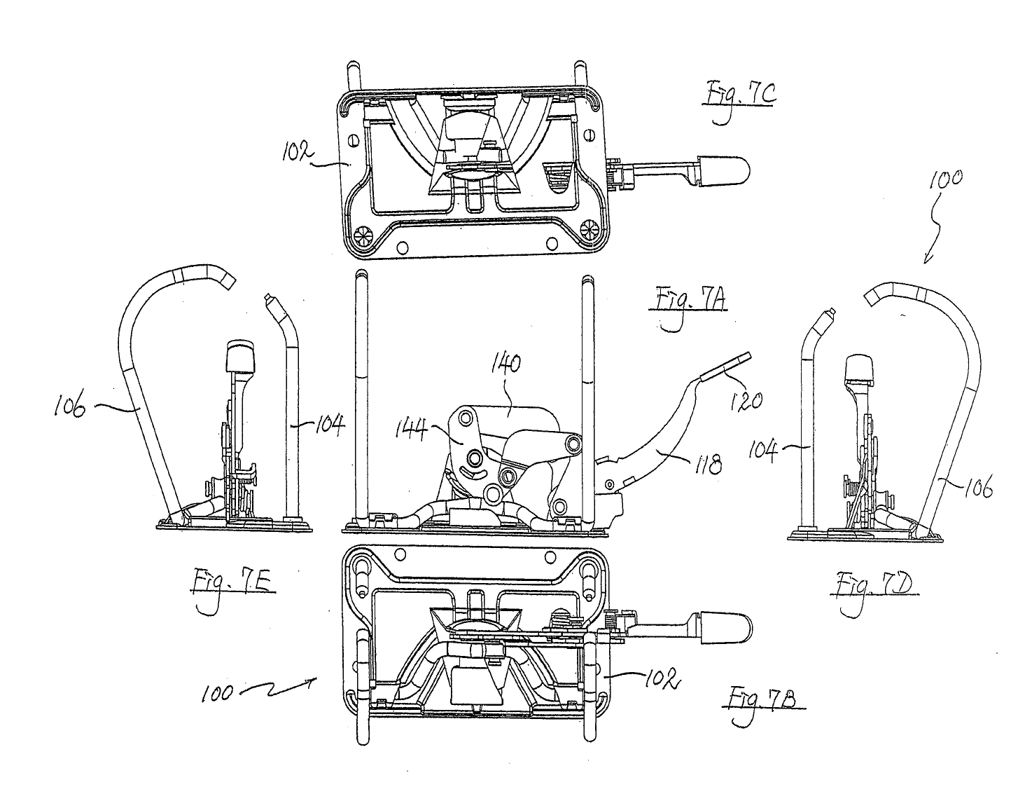

FIG. 7A is a front view of the mechanism shown in FIG. 1A in a ring-open configuration;

FIG. 7B is a top view of the mechanism shown in FIG. 7A;

FIG. 7C is a bottom view of the mechanism shown in FIG. 7A;

FIG. 7D is a left side view of the mechanism shown in FIG. 7A;

FIG. 7E is a right side view of the mechanism shown in FIG. 7A;

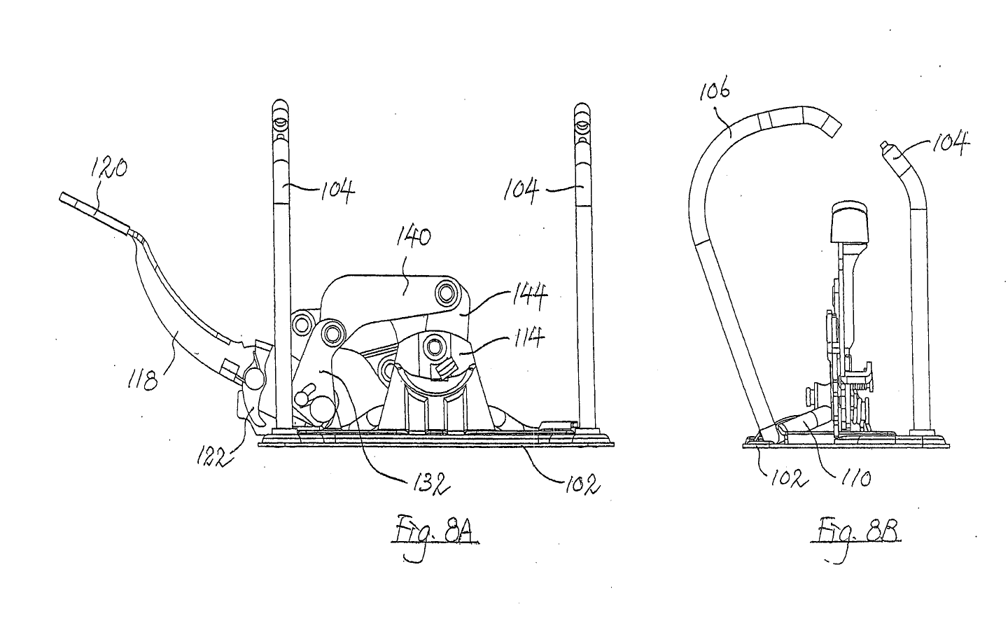

FIG. 8A is a r ear view of the mechanism shown in FIG. 7A;

FIG. 8B is a left side view of the mechanism shown in FIG. 8A;

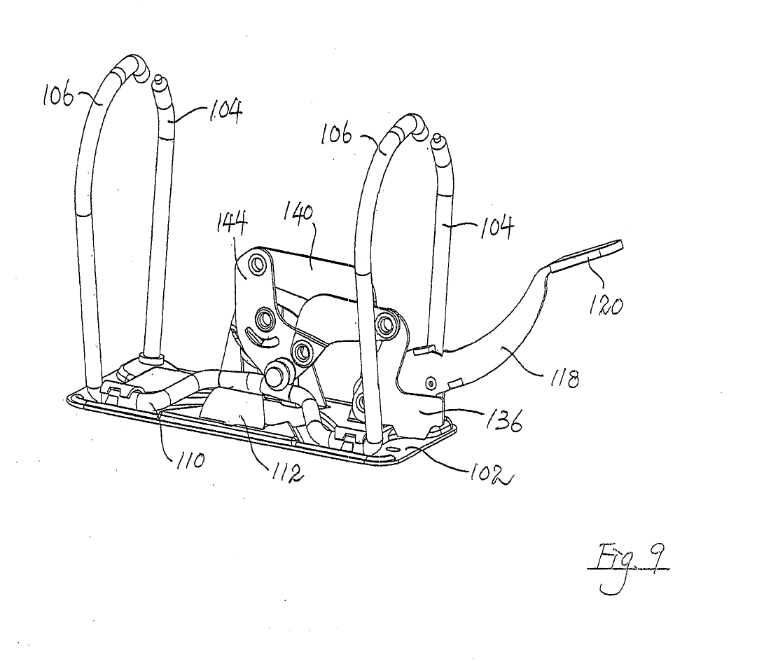

FIG. 9 is a top front perspective view of the mechanism shown in FIG. 7A;

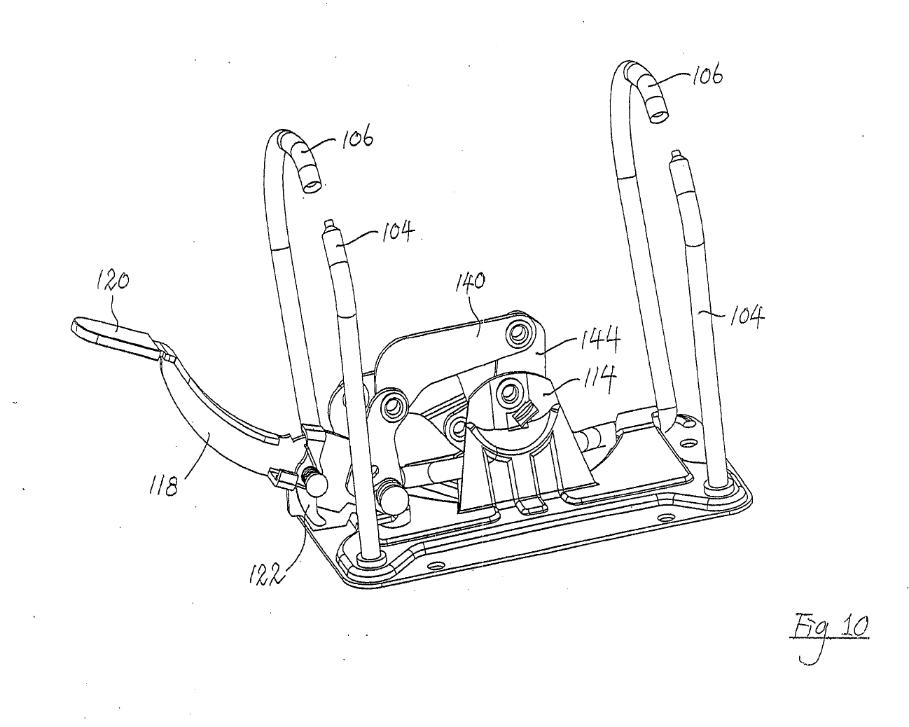

FIG. 10 is a top rear perspective view of the mechanism shown in FIG. 9;

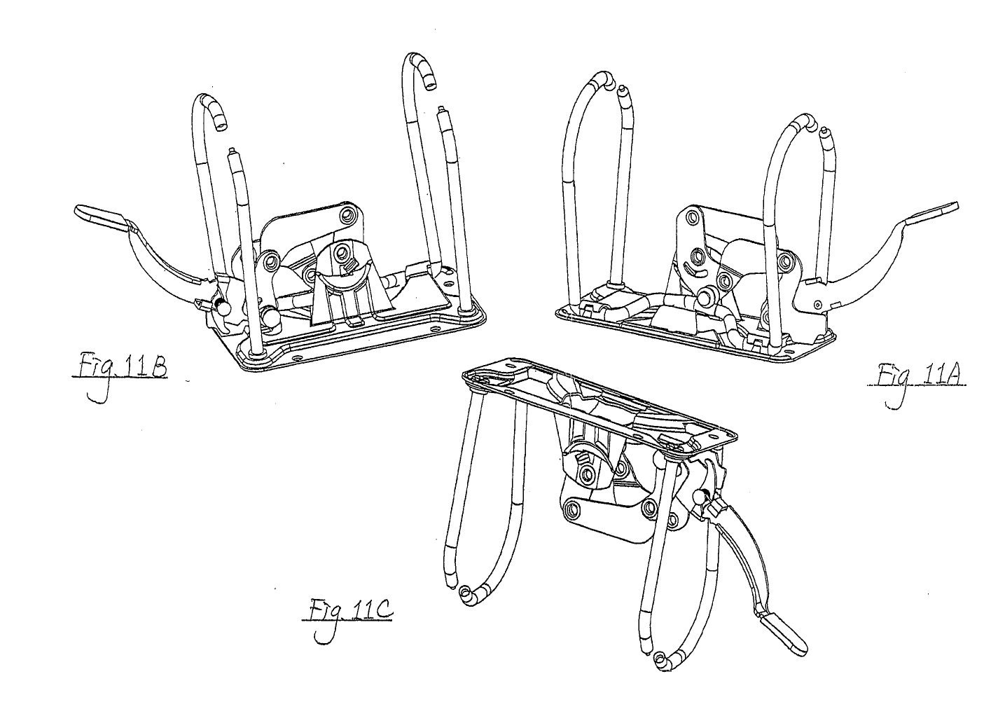

FIGS. 11A to 11C are various perspective views of the mechanism shown in FIG. 7A;

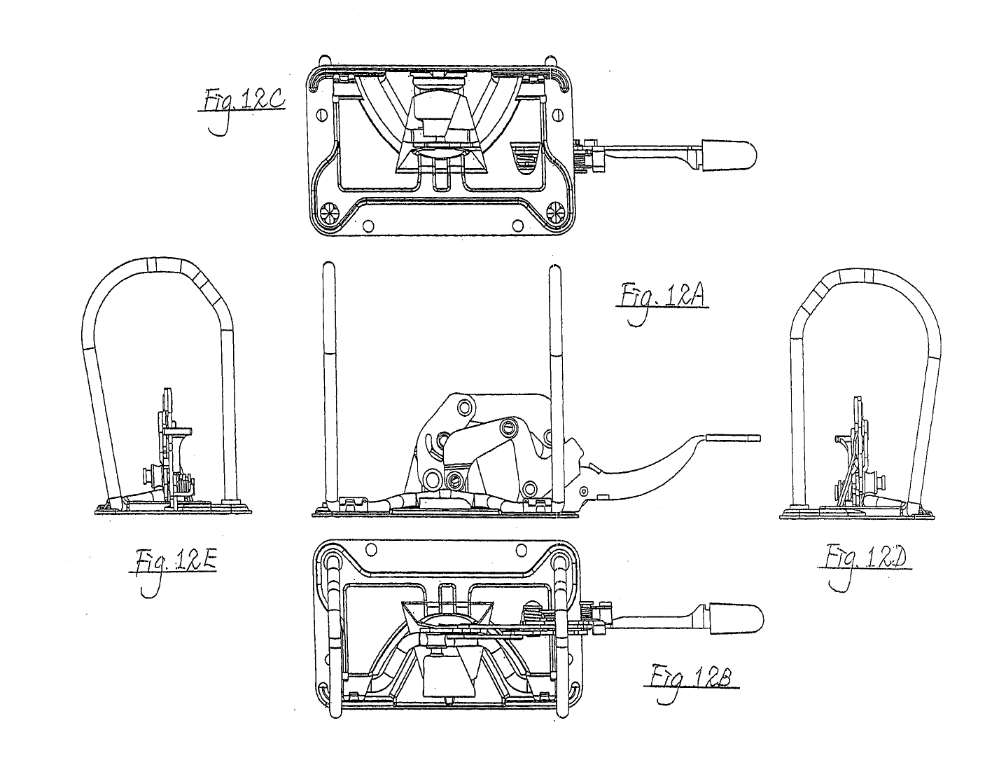

FIG. 12A is a front view of the mechanism shown in FIG. 1A in a ring-closed configuration, in which the lever is in a lowest position;

FIG. 12B is a top view of the mechanism shown in FIG. 12A;

FIG. 12C is a bottom view of the mechanism shown in FIG. 12A;

FIG. 12D is a left side view of the mechanism shown in FIG. 12A;

FIG. 12E is a right side view of the mechanism shown in FIG. 12A;

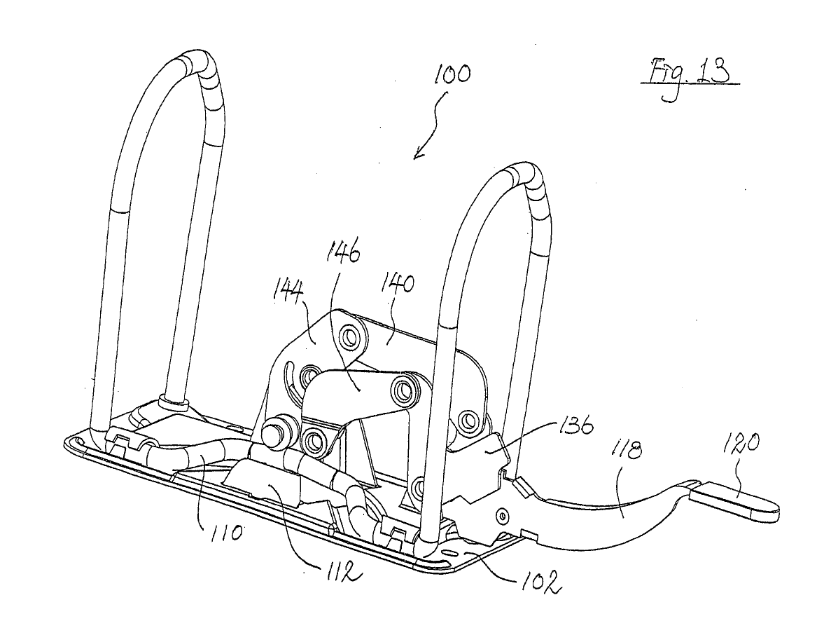

FIG. 13 is a top front perspective view of the mechanism shown in FIG. 12A;

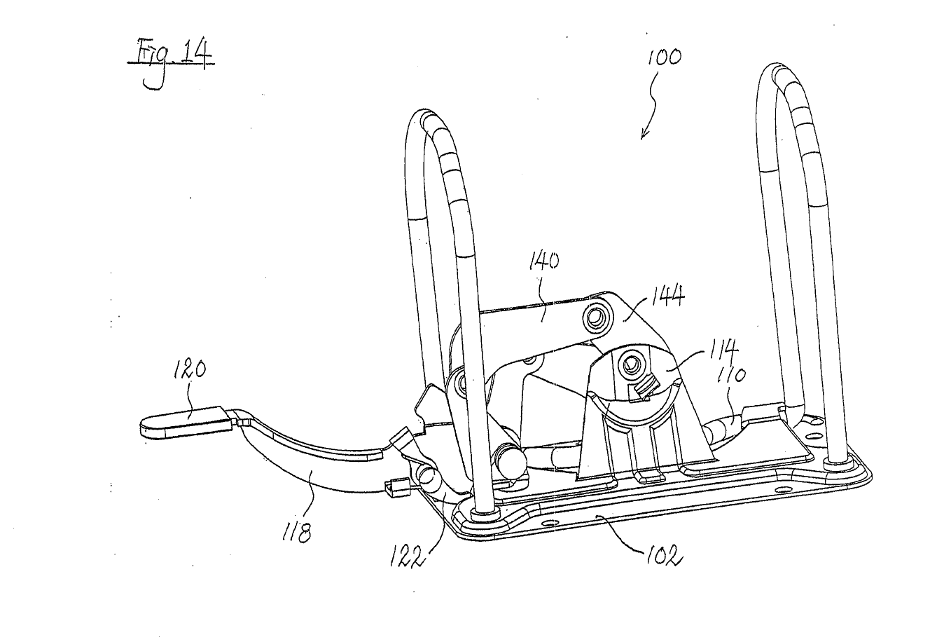

FIG. 14 is a top rear perspective view of the mechanism shown in FIG. 12A;

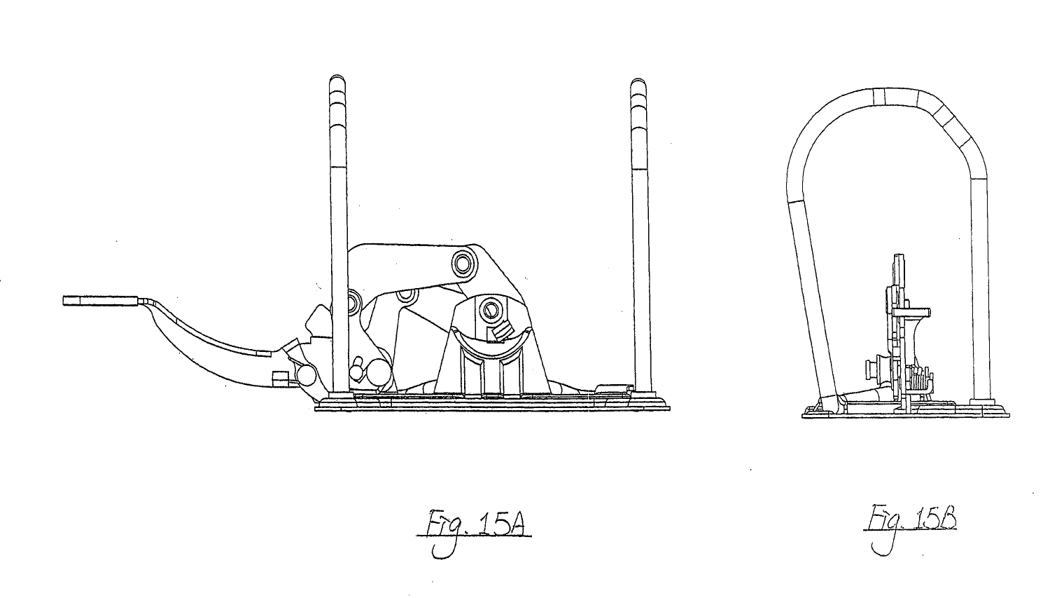

FIG. 15A is a rear side view of the mechanism shown in FIG. 12A;

FIG. 15B is a left side view of the mechanism shown in FIG. 15A;

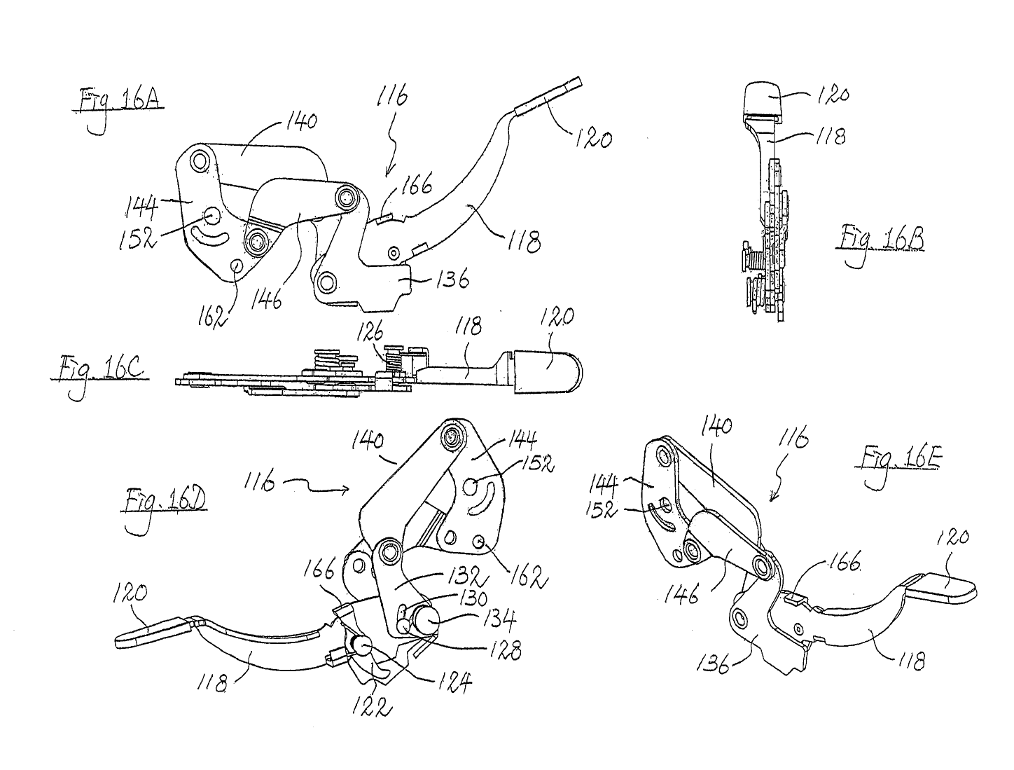

FIG. 16A is a front view of lever assembly of the mechanism shown in FIG. 1A;

FIG. 16B is a left side view of the lever assembly shown in FIG. 16A;

FIG. 16C is a top view of the lever assembly shown in FIG. 16A;

FIG. 16D is a rear perspective view of the lever assembly shown in FIG. 16A;

FIG. 16E is a front perspective view of the lever assembly shown in FIG. 16A;

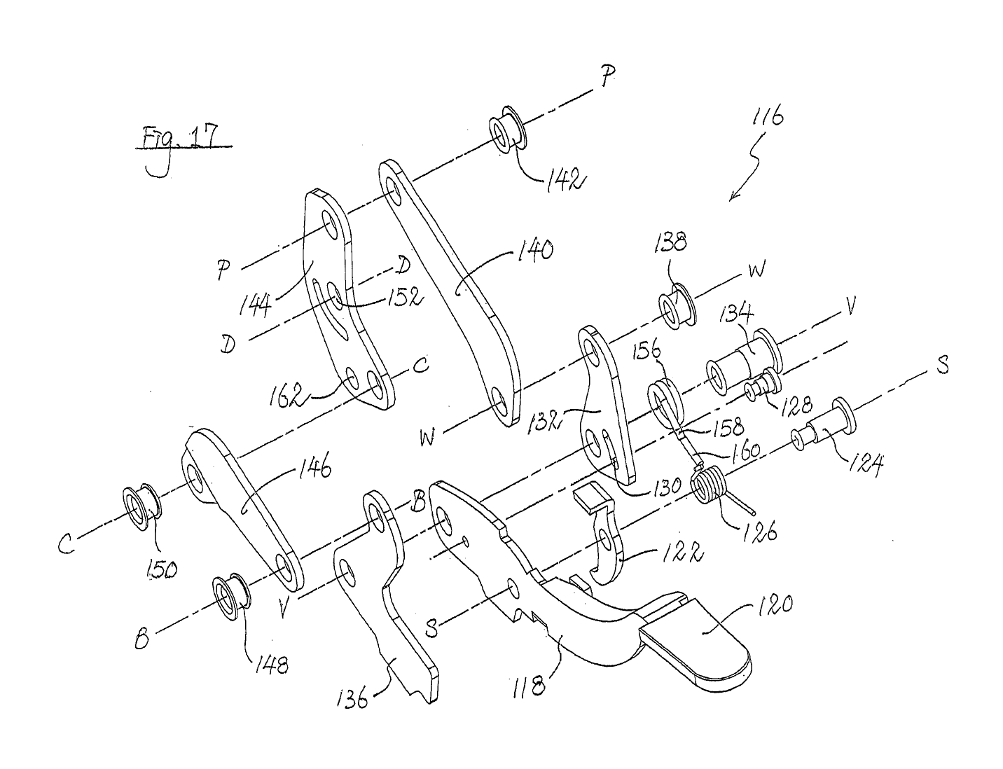

FIG. 17 is an exploded view of the lever assembly shown in FIG. 16A;

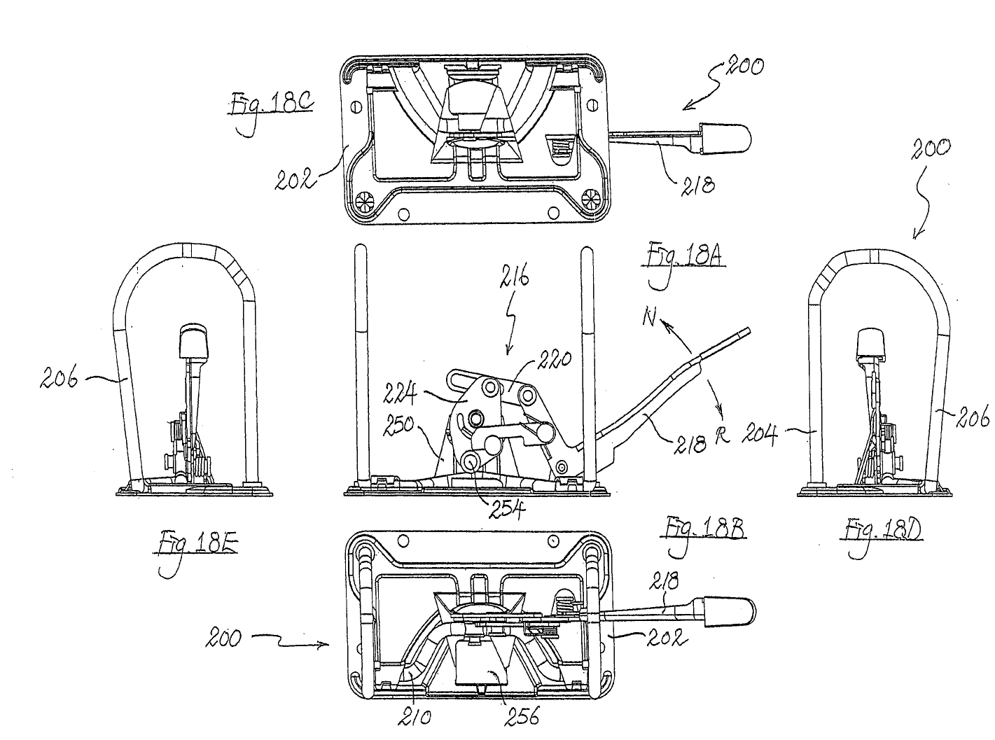

FIG. 18A is a front view of a lever-arch type file mechanism according to a second embodiment of the present invention, in a ring-closed configuration;

FIG. 18B is a top view of the mechanism shown in FIG. 18A;

FIG. 18C is a bottom view of the mechanism shown in FIG. 18A;

FIG. 18D is a left side view of the mechanism shown in FIG. 18A;

FIG. 18E is a right side view of the mechanism shown in FIG. 18A;

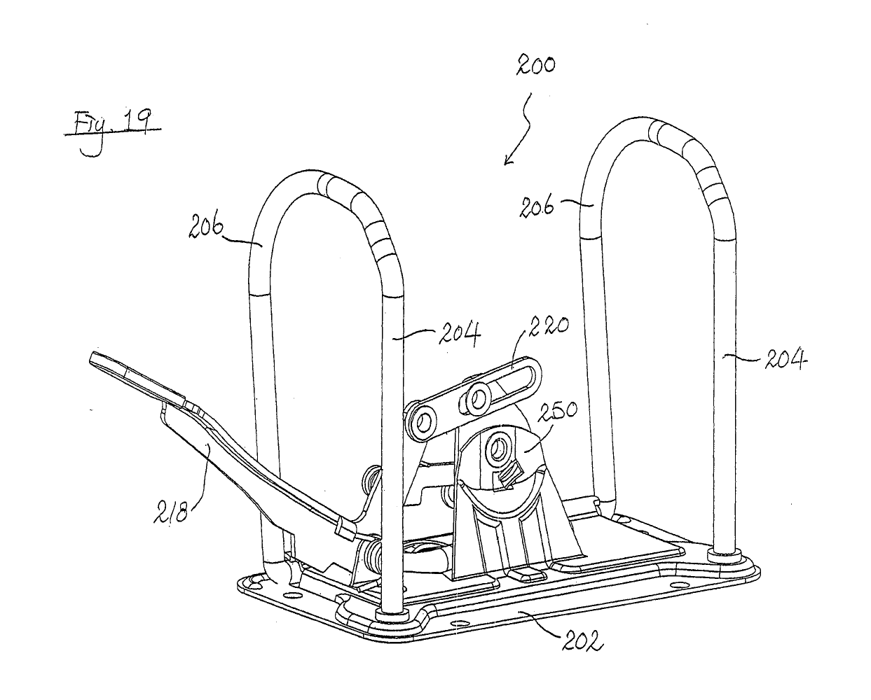

FIG. 19 is a top rear perspective view of the mechanism shown in FIG. 18A;

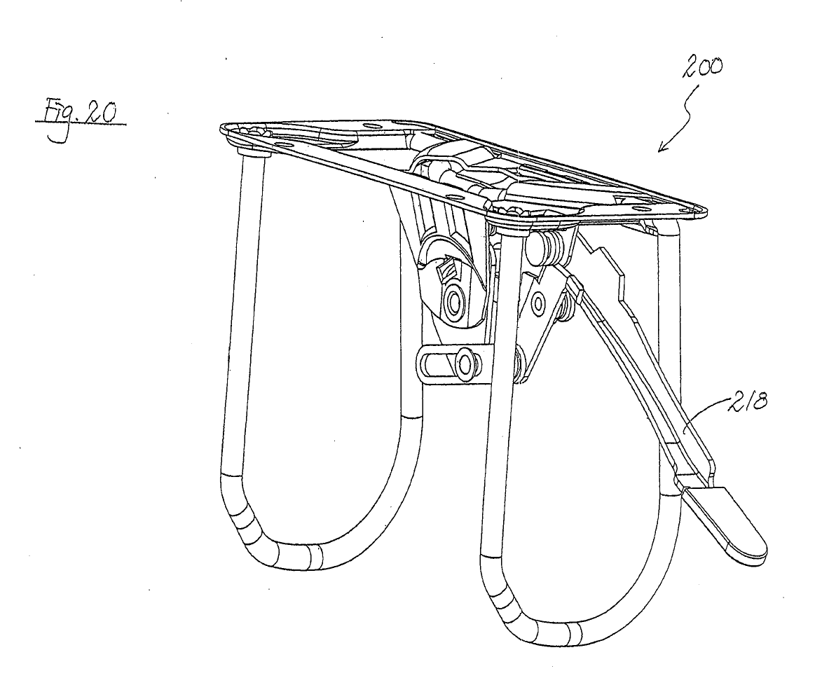

FIG. 20 is a bottom rear perspective view of the mechanism shown in FIG. 18A;

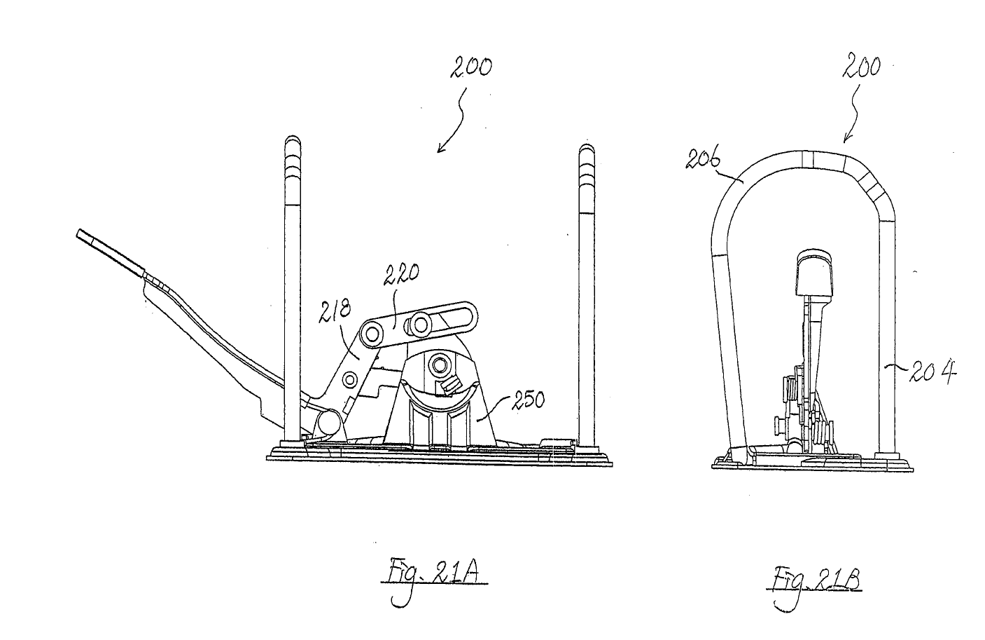

FIG. 21A is a rear side view of the mechanism shown in FIG. 18A;

FIG. 21B is a left side view of the mechanism shown in FIG. 21A;

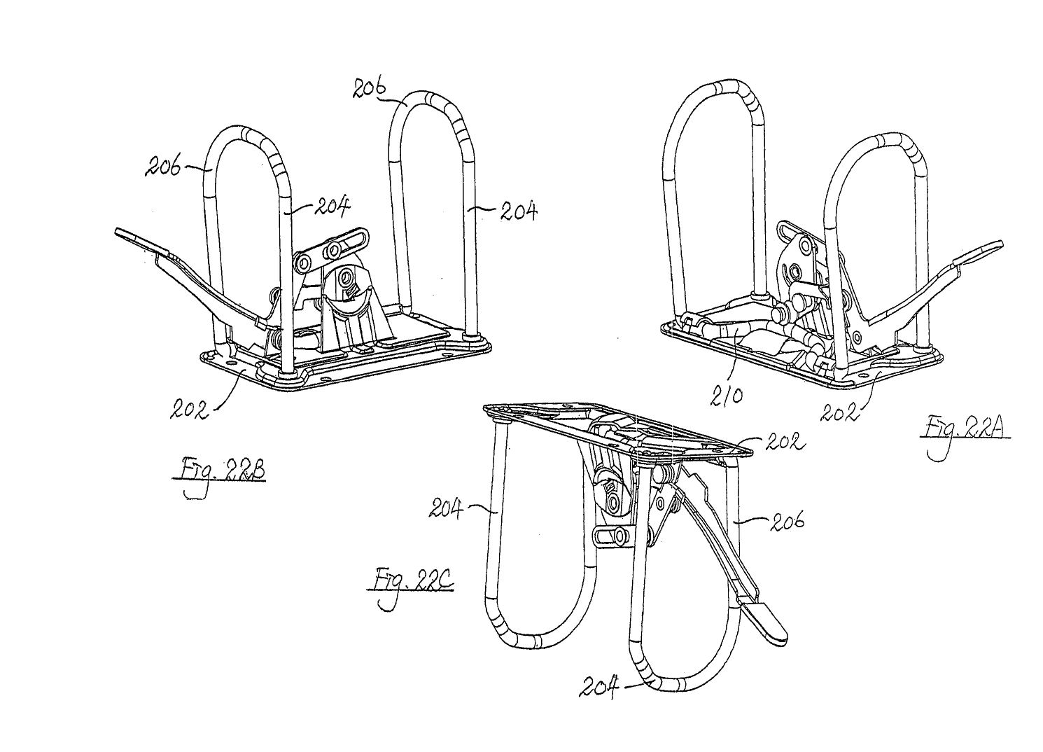

FIGS. 22A to 22C are various perspective views of the mechanism shown in FIG. 18A;

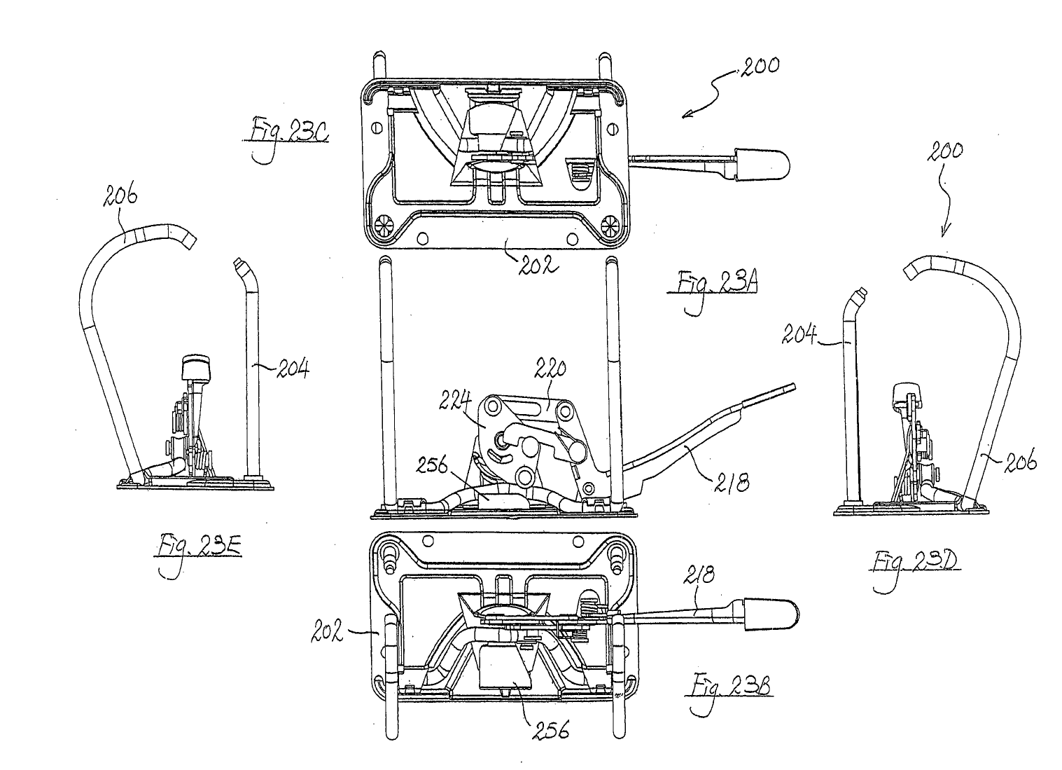

FIG. 23A is a front view of the mechanism shown in FIG. 18A in a ring-open configuration;

FIG. 23B is a top view of the mechanism shown in FIG. 23A;

FIG. 23C is a bottom view of the mechanism shown in FIG. 23A;

FIG. 23D is a left side view of the mechanism shown in FIG. 23A;

FIG. 23E is a right side view of the mechanism shown in FIG. 23A;

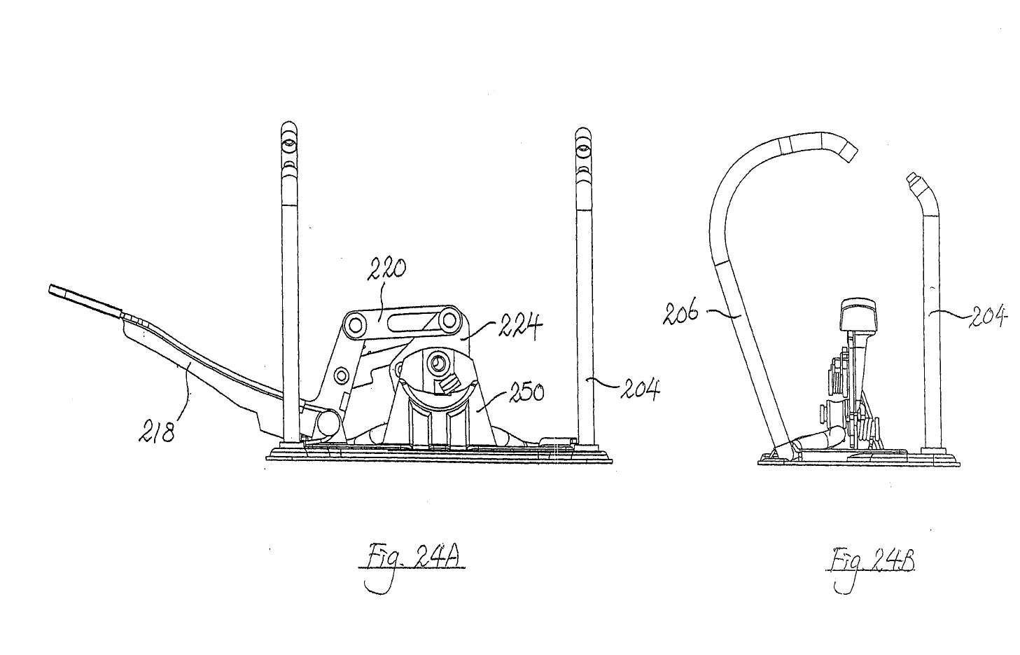

FIG. 24A is a rear view of the mechanism shown in FIG. 23A;

FIG. 24B is a left side view of the mechanism shown in FIG. 24A;

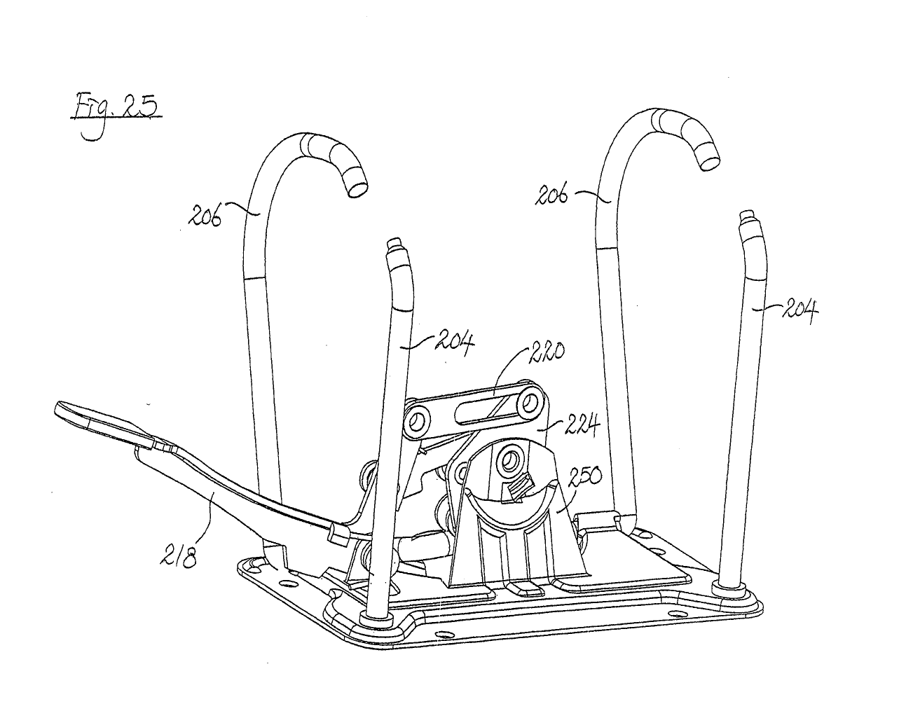

FIG. 25 is a rear perspective view of the mechanism shown in FIG. 23A;

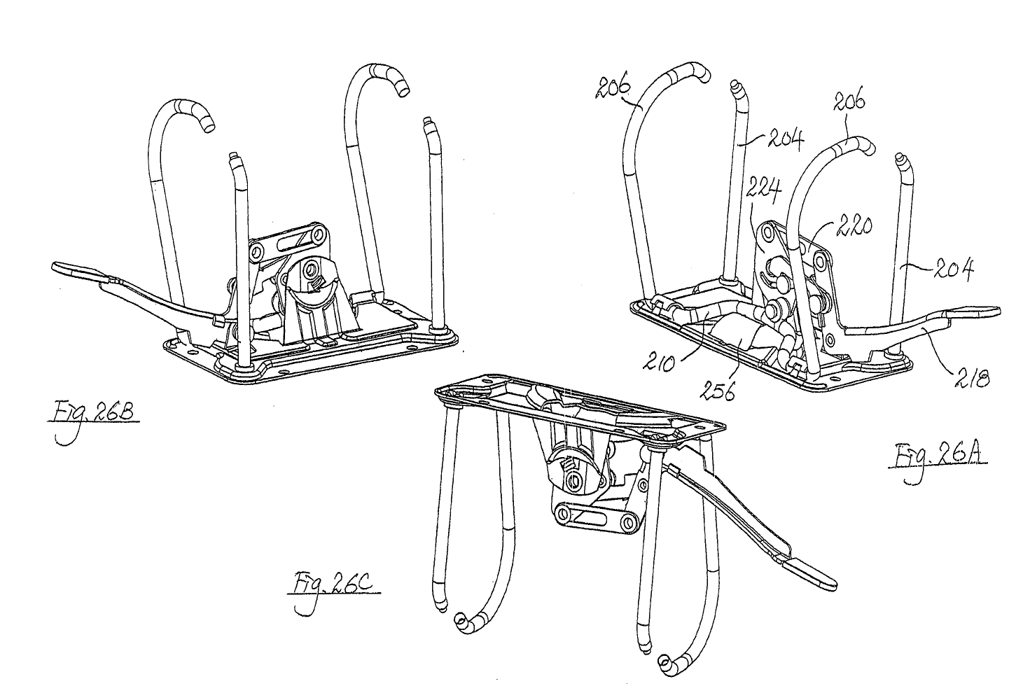

FIGS. 26A to 26C are various perspective views of the mechanism shown in FIG. 25;

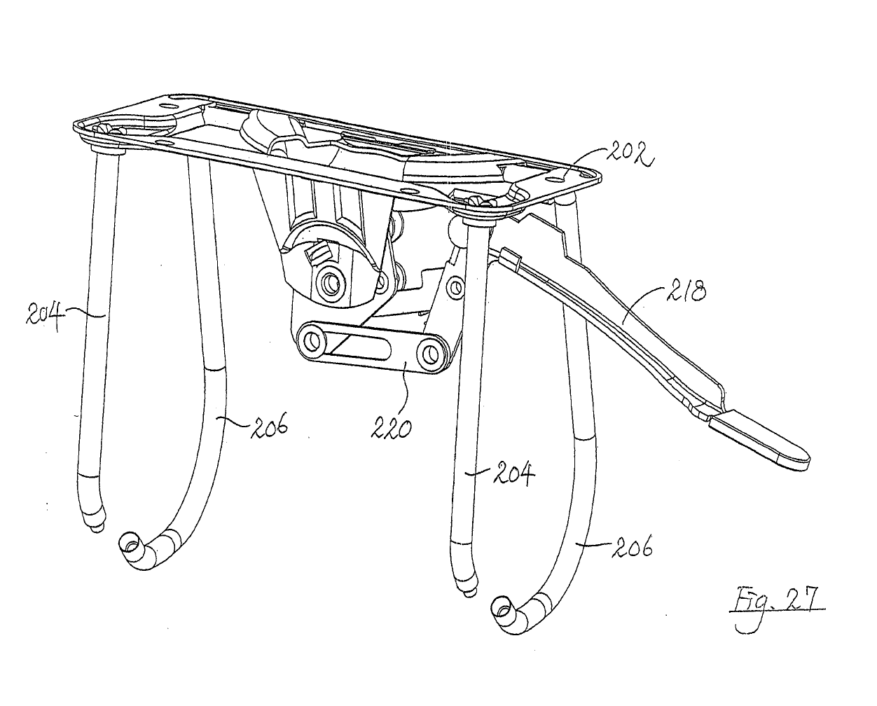

FIG. 27 is a bottom rear perspective view of the mechanism shown in FIG. 25;

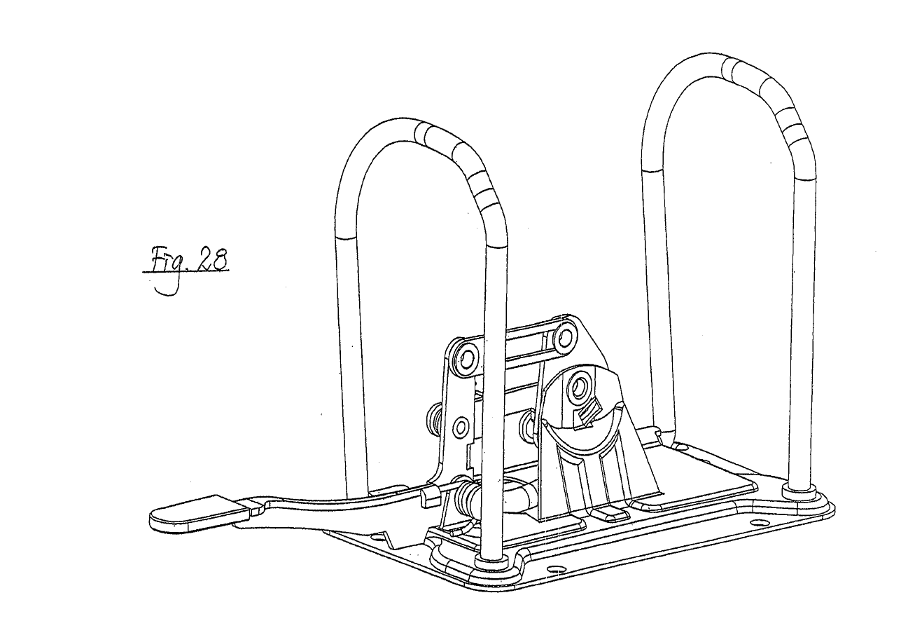

FIG. 28 is a top rear perspective view of the mechanism shown in FIG. 18A in a ring-closed configuration, in which the lever is in a lowest position;

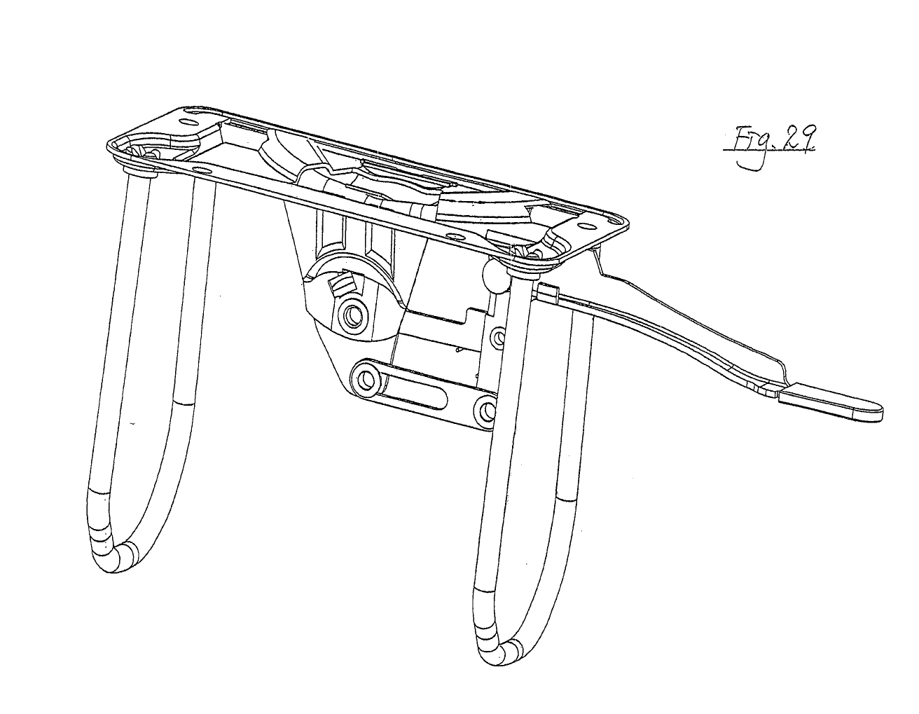

FIG. 29 is a bottom rear perspective view of the mechanism shown in FIG. 28;

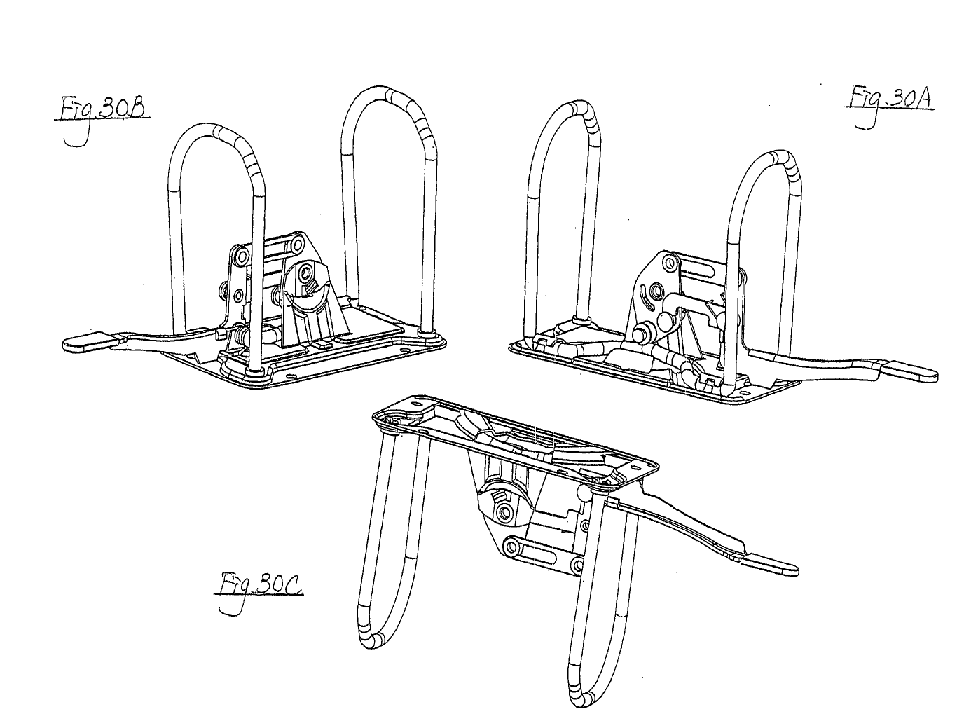

FIGS. 30A to 30C are various perspective views of the mechanism shown in FIG. 28;

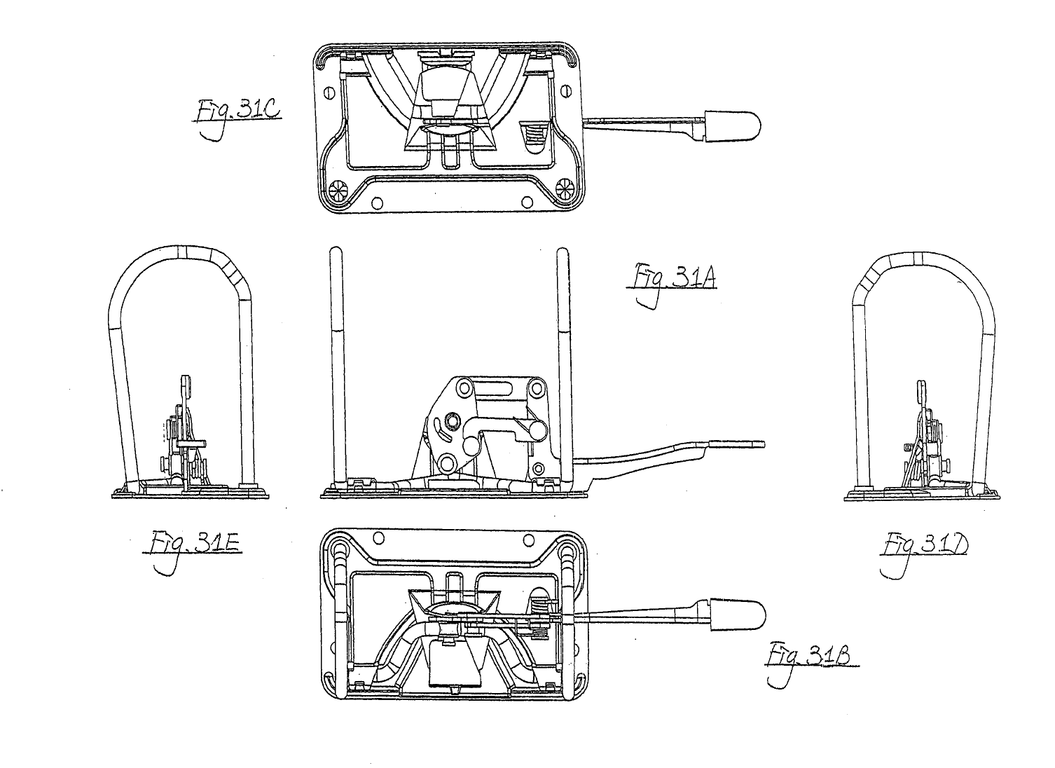

FIG. 31A is a front view of the mechanism shown in FIG. 28;

FIG. 31B is a top view of the mechanism shown in FIG. 31A;

FIG. 31C is a bottom view of the mechanism shown in FIG. 31A;

FIG. 31D is a left side view of the mechanism shown in FIG. 31A;

FIG. 31E is a right side view of the mechanism shown in FIG. 31A;

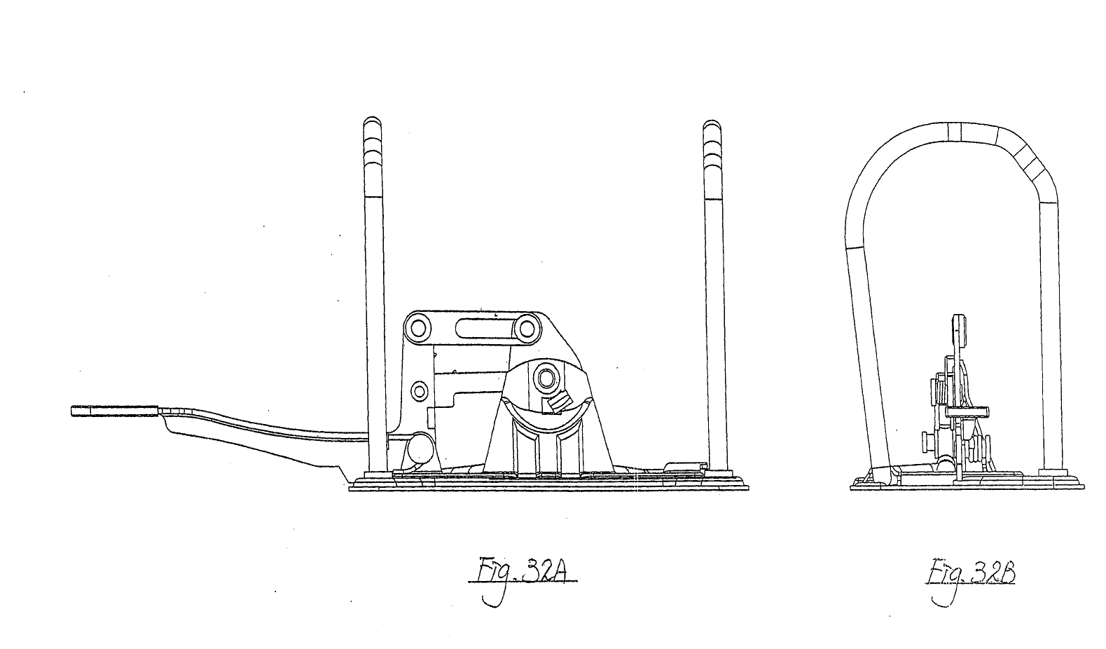

FIG. 32A is a rear view of the mechanism shown in FIG. 31A;

FIG. 32B is a left side view of the mechanism shown in FIG. 32A;

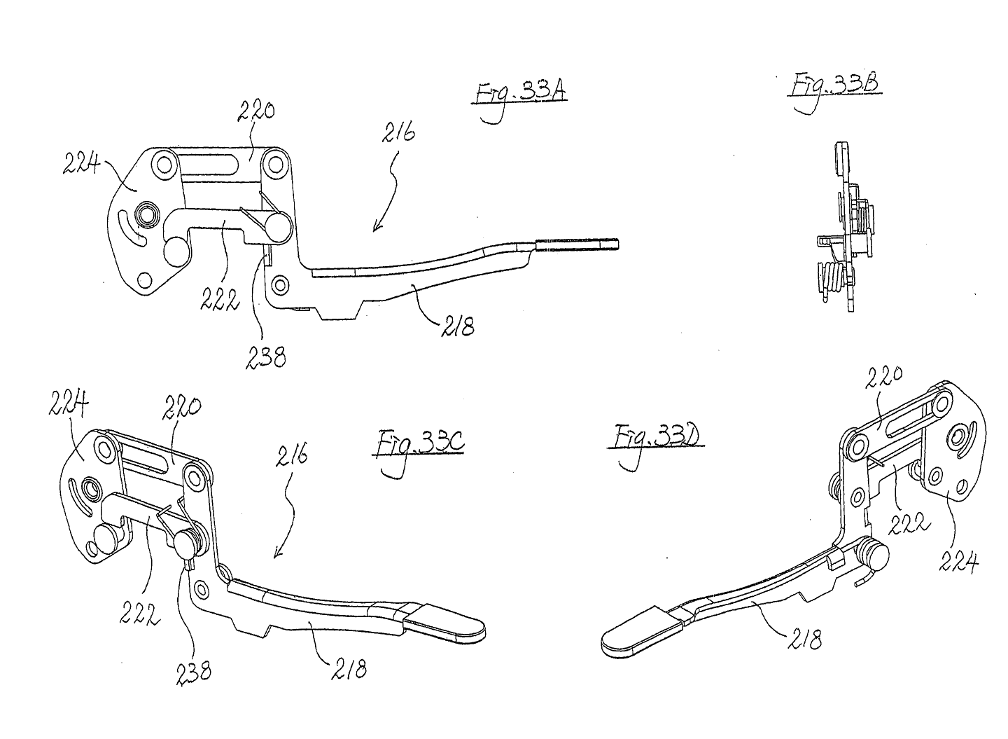

FIG. 33A is a front view of the lever assembly of the mechanism shown in FIG. 18A;

FIG. 33B is a left side view of the lever assembly shown in FIG. 33A;

FIG. 33C is a front perspective view of the lever assembly shown in FIG. 33A;

FIG. 33D is a rear perspective view of the lever assembly shown in FIG. 33A;

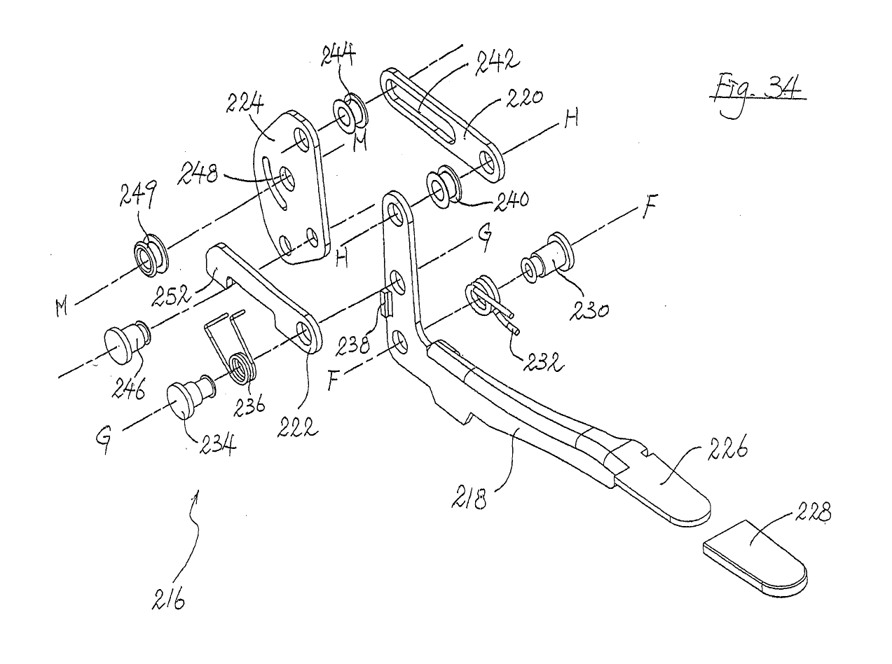

FIG. 34 is an exploded view of the lever assembly shown in FIG. 33A;

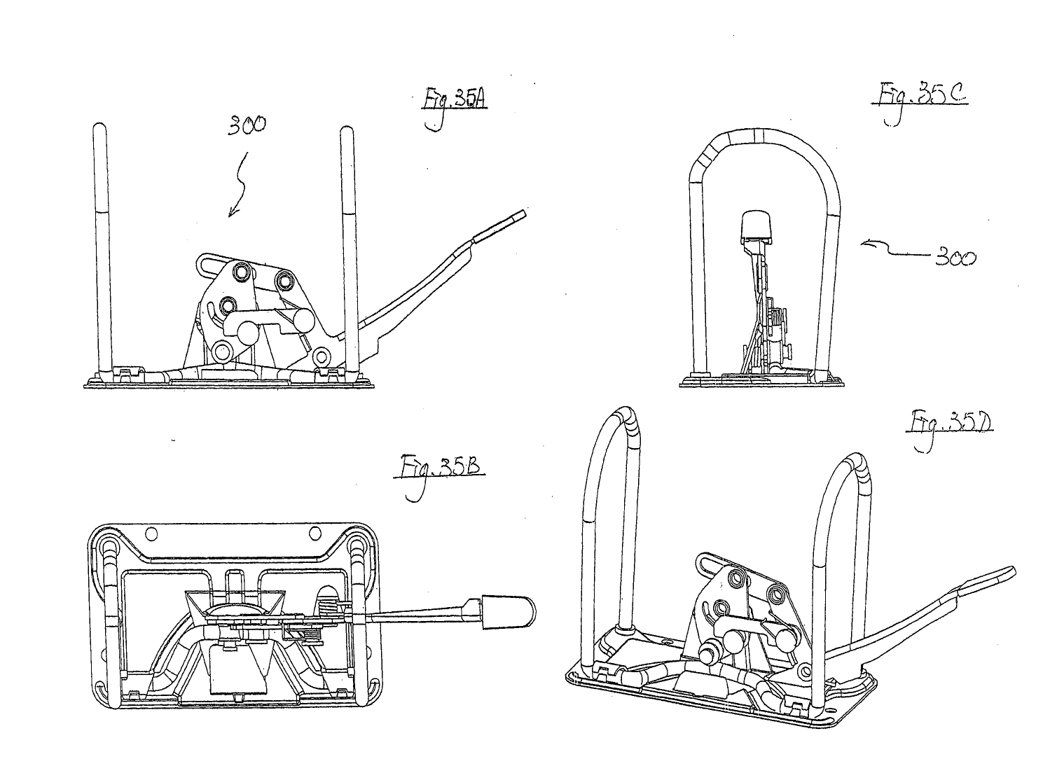

FIG. 35A is a front view of a lever-arch type file mechanism according to a third embodiment of the present invention, in a ring-closed configuration;

FIG. 35B is a top view of the mechanism shown in FIG. 35A;

FIG. 35C is a left side view of the mechanism shown in FIG. 35A;

FIG. 35D is a perspective view of the mechanism shown in FIG. 35A;

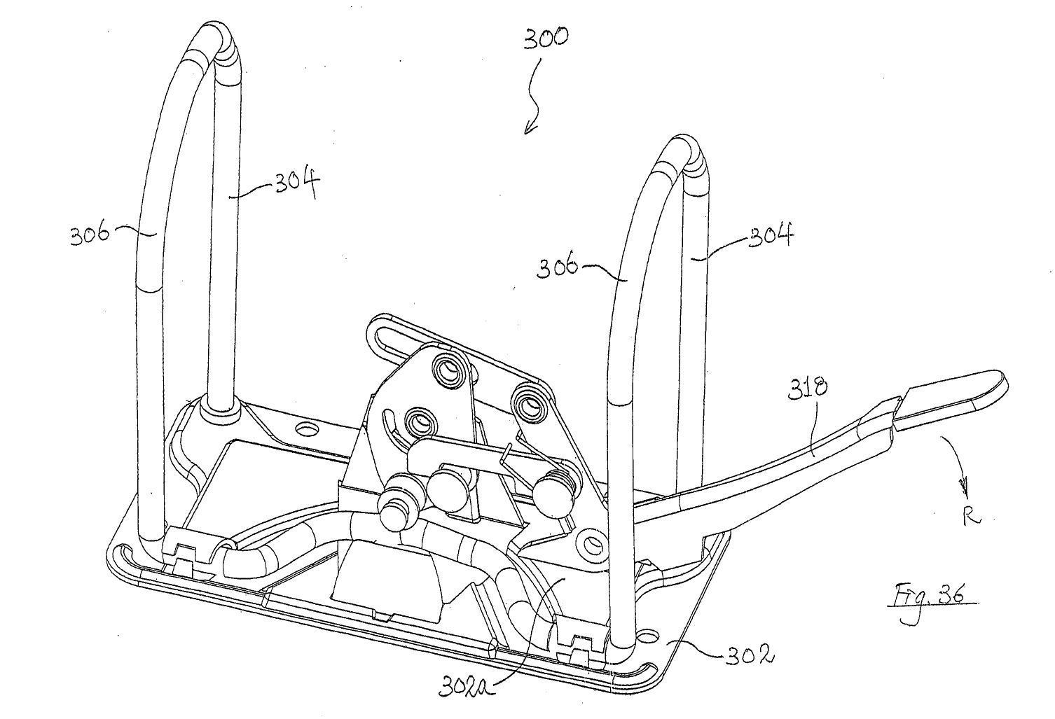

FIG. 36 is an enlarged perspective view of the mechanism shown in FIG. 35D;

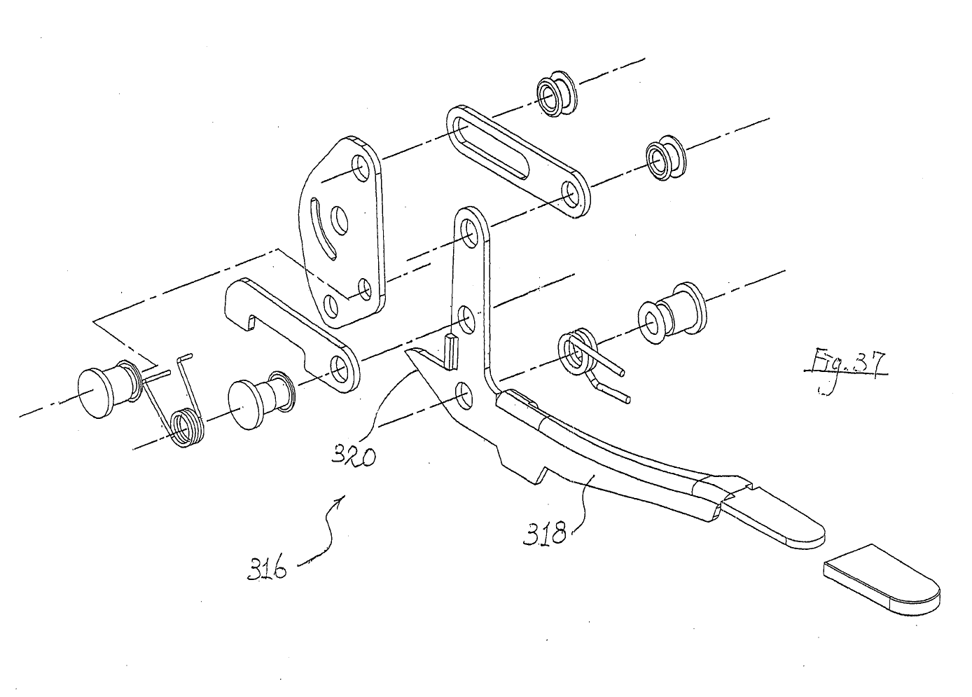

FIG. 37 is an exploded perspective view of the lever assembly of the mechanism shown in FIG. 35A;

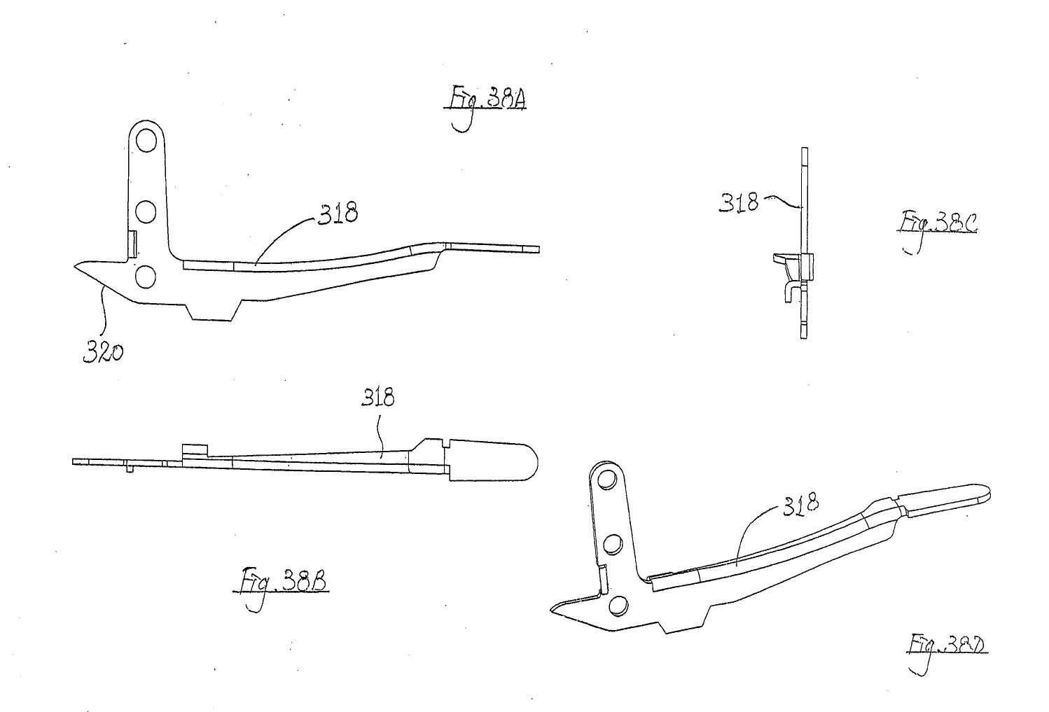

FIG. 38A is a front view of the lever of the lever assembly shown in FIG. 37;

FIG. 38B is a bottom view of the lever shown in FIG. 38A;

FIG. 38C is a left side view of the lever shown in FIG. 38A; and

FIG. 38D is a perspective view of the lever shown in FIG. 38A.

Various views of a lever-arch type file mechanism according to a first embodiment of the present invention, in a stable ring-closed configuration, are shown in FIGS. 1A to 5B, and generally designated as 100.

The mechanism 100 includes a base 102, which may be made of a metal sheet. Two posts 104 are fixedly secured to the base 102, and two arches 106 are engaged by a pair of clamps 108 close to the base 102 whereby the arches 106 are pivotable relative to the base 102 and the posts 104 about an axis T-T. The arches 106 are joined with each other via a crank portion 110 which is fixed and integrally formed with the arches 106. By way of such an arrangement, the crank portion 110 may be caused to pivot to bring about simultaneous pivotal movement of the arches 106 between a first position in which free ends of the arches 106 mate with free ends of the posts 104 (as shown in FIGS. 1A to 5B) to form two rings extending upwardly from the base 102 (“ring-closed configuration”) for retaining pieces of hole-punched paper, and a second position in which free ends of the arches 106 are out of engagement with free ends of the posts 104, thus opening the two rings (“ring-open configuration”) to allow pieces of hole-punched paper to be retrieved from or inserted into the posts 104 and/or the arches 106.

Beneath the crank portion 110 is a spring leaf 112 which acts upwardly on the crank portion 110 from below. By way of such an arrangement, the spring leaf 112 biases the arches 106, via the crank portion 110, to pivot away from the posts 104, i.e. to the ring-open configuration. A metal plate 114 extends generally upwardly from the base 102. The plate 114 is formed integrally with the base 102, and may, for example, be punched out from the same piece of metal sheet with which the base 102 is made.

The mechanism 100 has a lever assembly, generally designated as 116 (see FIGS. 16A to 17). The lever assembly 116 has a lever 118 with a free end 120 which may be operated manually by a user to pivot the lever 118 upwardly or downwardly relative to the base 102. In the configuration as shown in FIGS. 1A to 5B, the lever 118 occupies a stable position.

Combining FIGS. 1A to 5B and FIGS. 16A to 17, it can be seen that the lever 118 carries a link 122. In particular, the link 122 is engaged with the lever 118 via a rivet 124 for relative pivotal movement about an axis S-S. The link 122 is biased by a spring 126 to the position relative to the lever 118 as shown in FIGS. 3, 5A, 16D and 16E.

The lever 118 is also engaged with a link 132 via a rivet 128 which is partly received within a slot 130 of the link 132, such that the rivet 128 may reciprocate along the slot 130. An end of the lever 118 is engaged via a rivet 134 with the link 132 and a link 136 such that the lever 118 and the links 132, 136 are all pivotable about an axis V-V. It can be seen from FIGS. 1A to 5B that the axis V-V is fixed relative to the base 102.

The link 132 is engaged via a rivet 138 with a first end of a link 140 for relative pivotal movement about an axis W-W. A second end of the link 140 is engaged via a rivet 142 with a rear surface of a link 144 for relative pivotal movement about an axis P-P. The lever 118 is thus connected and engaged indirectly with the rear surface of the link 144 via the links 132, 140.

Turning now to the link 136, such is engaged with a first end of a link 146 via a rivet 148 for relative pivotal movement about the axis B-B. A second end of the link 146 is engaged via a rivet 150 with a front surface of the link 144 for relative pivotal movement about an axis C-C. Thus, the lever 118 is connected and engaged indirectly with the front surface of the link 144 via the links 136, 146.

The link 144 has a hole 152 for engagement with a hole (not shown) of the plate 114 via a rivet 154 so that the link 144 is swivellable relative to the plate 114 about an axis D-D. As the plate 114 is fixed relative to the base 102, the axis D-D is also fixed relative to the base 102. It can also be seen that the axes P-P, D-D, C-C, W-W, B-B, V-V and S-S are all parallel to one another and perpendicular to the axis T-T As to the axes V-V and D-D which are fixed relative to the base 102, the distance between the base 102 and the axis D-D is longer than that between the base 102 and the axis V-V.

It should also be noted that a spring 156 is engaged with the link 132 via the rivet 134, such that a first free end 158 of the spring 156 acts on the rivet 128 from below and a second free end 160 of the spring 156 acts on the base 102. By way of such an arrangement, the spring 156 biases the rivet 128 towards the position at the upper end of the slot 130.

The link 144 has a hole 162 for engagement with a roller 164 for free rotation about its longitudinal axis relative to the link 144. As can be seen in FIGS. 1A and 4, when in the ring-closed configuration, the roller 164 acts on the crank portion 110 from above against the upward biasing force of the spring leaf 112 to maintain the mechanism 100 in the ring-closed configuration.

Turning now to FIG. 6, the lever 118 may be pivoted relative to the base 102, from its normal stable position marked “J” (“J position”), to an intermediate position marked “K” (“K position”) to open the rings, then to a lowermost position marked “L” (“L position”) to close the rings.

Starting from the normal stable J position, upon downward pivoting movement of the lever 118 (i.e. in the direction indicated by the arrow Z in FIG. 6) through an angle from the J position to the K position, an extension 166 of the link 122 is carried by the lever 118 to pivot relative to the fixed axis V-V to engage and press the link 136 to pivot relative to the axis V-V in the same downward direction. By reason of such a pivotal movement of the link 136, the link 144 is pulled, at a point where the link 146 is connected with the link 144 (which point being between the base 102 and the fixed axis D-D), to pivot about the fixed axis D-D in a direction opposite to that of the arrow Z, whereby the roller 164 is pivoted away from the crank portion 110. The spring leaf 112 then flexes upwardly to pivot the crank portion 110 about the axis T-T to pivot the arches 106 away from the posts 104 so as to move the mechanism 100 from the ring-closed configuration to the ring-open configuration.

If, at this point, the downward pressing force acting on the lever 118 (e.g. at the free end 120) is released, the spring 156 will move the lever 118 from the K position back to the normal stable J position, without changing the mechanism 100 back to the ring-closed configuration. The mechanism 100 will then be in the ring-open configuration as shown in FIGS. 7A to 11C. It can be seen that, in this stable ring-open configuration, the extension 166 of the link 122 rests on an upper edge of the lever 118 and is out of engagement with the link 136. Thus, the engagement between the link 122 and the link 136 is a releasable one.

If, after the lever 118 is pivoted from the J position to the K position to move the mechanism 100 to the ring-open configuration, the lever 118 is pivoted further in the direction indicated by the arrow Z to the L position, a lower curved edge of the link 122 slides on and relative to the base 102 by pivoting about the axis S-S. As the link 122 is out of engagement with the link 136 when the lever 118 is in the K position, further downward pivotal movement of the lever 118 about the axis V-V from the K position to the L position will not bring about any corresponding movement of the link 136. On the other hand, such a further downward pivotal movement of the lever 118 will pull the link 140, which in turn exerts a pulling force on a point where the link 140 is connected with the link 144 (which point being beyond the base 102 and the fixed axis D-D). This causes the link 144 to pivot about the axis D-D in the direction indicated by the arrow Z in FIG. 6, to bring the roller 164 back to the position as shown in FIGS. 12A to 12D, 13 and 15B. During this return movement of the roller 164, it presses on the crank portion 110 to pivot the arches 106, against the upward biasing force of the spring leaf 112, back to the position as shown in FIGS. 12A to 12D and 13 to 15B, so as to bring the rings back to the ring-closed configuration. When the downward pressing force on the lever 118 is then released, the lever 118 is returned to the J position by the spring 156, so that the mechanism will assume the ring-closed configuration as shown in FIGS. 1A to 1E.

Returning to FIG. 6, the lever 118 may be pivoted upwardly (i.e. in a direction opposite to that indicated by the arrow Z) from the J position to move the mechanism 100 from the ring-closed configuration to the ring-open configuration. In this connection, when the lever 118 is pivoted upwardly from the J position, as the rivet 128 is already at the upper position of the slot 130 of the link 132, such will cause the link 132 to pivot about the axis V-V to pivot in a direction opposite to that indicated by the arrow Z. Such consequently pushes the link 140, which in turn exerts a pushing force on a point where the link 140 is connected with the link 144, to cause the link 144 to pivot in a direction opposite to that indicated by the arrow Z. As discussed above, such will move the mechanism 100 from the ring-closed position to the ring-open configuration. When the force thus acting on the lever 118 is released, the lever 118 will return downwardly to the J position.

Such a lever-arch type file mechanism 100 may be fixedly engaged, e.g. by rivets, with a substrate, e.g. a cardboard cover, to form a paper retaining device, e.g. a lever-arch type file.

Various views of a lever-arch type file mechanism according to a second embodiment of the present invention, in a stable ring-closed configuration, are shown in FIGS. 18A to 22C, and generally designated as 200.

The basic structure of the mechanism 200 is generally similar to that of the mechanism 100 discussed above. The mechanism 200 has a base 202 to which a pair of posts 204 are fixedly secured. Two arches 206 are joined with and integrally formed with a crank portion 210 for simultaneous pivotal movement relative to the posts 204.

The main difference between this mechanism 200 and the mechanism 100 discussed above resides in the lever assembly 216, as shown in FIGS. 33A to 34. This lever assembly 216 has one lever 218 and three links 220, 222, 224 connected with one another. More particularly, a free end 226 of the lever 218, which is made of metal, is fixed with a thumb pad 228 (which may be made of plastics) for enhancing comfort in use.

The lever 218 is engaged by a rivet 230 for pivotal movement about an axis F-F which is fixed relative to the base 202. A spring 232 is also engaged by the rivet 230 to act on the lever 218 and the base 202. The lever 218 is also engaged with a spring 236 and the link 222 by a rivet 234, to allow the link 222 to pivot relative to the lever 218 about an axis G-G, which moves with the lever 218. The spring 236 acts on the lever 218 and the link 222 to bias the link 222 towards a laterally extending stopper 238 of the lever 218.

The lever 218 is also engaged with the link 220 via a rivet 240 for relative pivotal movement about an axis H-H which moves with the lever 218. The link 220 has a slot 242 for engagement with a rivet 244 engaged with the link 224, allowing relative pivotal and sliding movement between the link 220 and the link 224. A stud 246 is fixedly engaged with the link 224, to establish releasable engagement with the link 222, in a manner to be discussed below. The link 224 has a hole 248 for engagement, via a rivet 249, with a plate 250, which is integrally formed with and fixed relative to the base 202, about an axis M-M which is also fixed relative to the base 202.

It can be seen from FIGS. 18A to 22C that, when the lever-arch type file mechanism 200 is in the stable ring-closed configuration, the rivet 244 is close or adjacent to an end of the slot 242 closer to the lever 218. In addition, a hook portion 252 of the link 222 is engaged with the stud 246 fixed to the link 224.

From the position as shown in FIGS. 18A to 22C, the lever 218 may be pivoted upwardly, i.e. in the direction indicated by the arrow N in FIG. 18A, relative to the base 202. Upon such a pivotal movement, the link 220 pushes the link 224, at a point beyond the base 202 and the axis M-M, to rotate in the same direction about the axis M-M, thus bringing a roller 254 carried by the link 224 to rotate in the same direction and away from the crank portion 210. Upon this pivotal movement of the roller 254, a spring leaf 256 flexes upwardly to pivot the crank portion 210 to bring about pivotal action of the arches 206 away from the posts 204, so as to move the mechanism 200 to the ring-open configuration as shown in FIGS. 23A to 27.

Alternatively, from the position as shown in FIGS. 18A to 22C, the lever 218 may be pivoted downwardly, i.e. in the direction indicated by the arrow R in FIG. 18A, relative to the base 202. Upon such a pivotal movement, the lever 218 pulls on the link 222, which in turn pulls the stud 246 (which is between the base 202 and the axis M-M) to cause the link 224 to rotate in the direction indicated by the arrow N in FIG. 18A, about the axis M-M. This will also bring the roller 254 to rotate away from the crank portion 210, thus allowing the mechanism 200 to assume the ring-open configuration. If the downwardly pressing force acting on the lever 218 is released, the spring 232 will cause the lever 218 to pivot slightly upward to assume the position as shown in FIGS. 23A to 27. It can be seen that, in this configuration, the rivet 244 is close or adjacent to an end of the slot 242 which is closer to the link 224.

On the other hand, if, after the lever 218 is pivoted downwardly to open the rings, the lever 218 is pivoted further downwardly to the position as shown in FIGS. 28 to 32B, the link 220 will pull the rivet 244, thus bringing the link 224 to rotate in the direction indicated by the arrow R as shown in FIG. 18A, to bring the roller 254 back to the position as shown in FIGS. 18A to 18E, to close the rings and bring the mechanism 200 to the ring-closed configuration. It can be seen from FIGS. 29, 30A, 30C and 31A that, when in this configuration, the hook portion 252 of the link 222 is out of engagement with the stud 246, and thus with the link 224. In addition, when in this configuration, the link 222 is prevented from pivoting further downwardly by the stopper 238 of the lever 218.

When the downwardly pressing force acting on the lever 218 is released, the lever 218 will be returned to the position as shown in FIGS. 18A to 18E by the biasing force of the spring 232. This will also bring the link 222 back to releasable engagement with the stud 246, as shown in FIGS. 18A to 18E.

Such a lever-arch type file mechanism 200 may also be fixedly engaged, e.g. by rivets, with a substrate, e.g. a cardboard cover, to form a paper retaining device, e.g. a lever-arch type file.

Various views of a lever-arch type file mechanism according to a third embodiment of the present invention, in a stable ring-closed configuration, are shown in FIGS. 35A to 38D, and generally designated as 300. The mechanism 300 is structurally similar to the lever-arch type file mechanism 200 shown in FIGS. 18A to 34. A main difference of this mechanism 300 from the mechanism 200 resides in a lever 318 of a lever assembly 316 of the mechanism 300.

As shown more clearly in FIGS. 37 to 38D, the lever 318 has a straight lower portion 320. When the mechanism 300 is in the ring-closed configuration as shown in FIGS. 35A to 36, the straight lower portion 320 abuts and lies on an upper surface 302a of a base 302. By way of such an arrangement, and as discussed above in relation to the mechanism 200, the lever 318 may be pivoted relative to the base 302 downwardly, i.e. in the direction indicated by the arrow R in FIG. 36, to firstly open a pair of rings formed by a pair of posts 304 and a pair of arches 306. Further downward pivotal movement of the lever 318 in the direction indicated by the arrow R will close the ring pairs. However, when in the ring-closed configuration as shown in FIGS. 35A to 36, because of the engagement between the straight lower portion 320 of the lever 318 and the upper surface 302a of the base 302, it is not possible to pivot the lever 318 relative to the base 302 upwardly, i.e. in a direction opposite to that indicated by the arrow R.

It should be understood that the above only illustrates an examples whereby the present invention may be carried out, and that various modifications and/or alterations may be made thereto without departing from the spirit of the invention.

It should also be understood that certain features of the invention, which are, for clarity, described in the context of separate embodiments, may be provided in combination in a single embodiment. Conversely, various features of the invention which are, for brevity, described in the context of a single embodiment, may also be provided separately or in any appropriate sub-combinations.

1. A lever-arch type file mechanism including:
a base;
at least two rings secured to and extending upwardly from the base for engaging holes in at least a piece of paper, each said ring including a post member fixed to said base and an arch member movable relative to said post member; and
a lever assembly operable to move said arch members relative to said post members between a ring-closed configuration in which said rings are closed and a ring-open configuration in which said rings are open;
wherein a lever member of said lever assembly is pivotable in a first direction from a first position (J) to a second position (K) to move said rings from said ring-closed configuration to said ring-open configuration, and subsequently pivotable in said first direction from said second position to a third position (L) to move said rings from said ring-open configuration to said ring-closed configuration.

2. A mechanism according to claim 1 wherein said lever member is pivotable among said first, second and third positions about an axis (V-V, F-F) which is fixed relative to said base.

3. A mechanism according to claim 1 wherein said rings are adapted to remain in said ring-open configuration upon movement of said lever member from said second position to said first position.

4. A mechanism according to claim 1 wherein said rings are adapted to remain in said ring-closed configuration upon movement of said lever member from said third position to said first position.

5. A mechanism according to claim 3 wherein said lever member is biased towards said first position.

6. A mechanism according to claim 5 wherein said lever member is spring-biased towards said first position.

7. A mechanism according to claim 1 wherein said lever member has a straight portion which, when said lever member of said lever assembly is in said first position, engages said base to prevent said lever member from being pivoted in a direction which is opposite to said first direction.

8. A lever-arch type file mechanism including:
a base;
at least two rings secured to and extending upwardly from the base for engaging holes in at least a piece of paper, each said ring including a post member fixed to said base and an arch member movable relative to said post member; and
a lever assembly operable to move said arch members relative to said post members between a ring-closed configuration in which said rings are closed and a ring-open configuration in which said rings are open;
wherein a lever member of said lever assembly is pivotable in a first direction to move said rings from said ring-closed configuration to said ring-open configuration;
wherein said lever member is pivotable in an opposite second direction to move said rings from said ring-closed configuration to said ring-open configuration.

9. A mechanism according to claim 8 wherein said lever member is pivotable in said first direction from a first position (J) to a second position (K) to move said rings from said ring-closed configuration to said ring-open configuration.

10. A mechanism according to claim 9 wherein said rings are adapted to remain in said ring-open configuration upon movement of said lever member from said second position to said first position.

11. A mechanism according to claim 8, wherein said lever member is pivotable in said second direction from a first position to a third position to move said rings from said ring-closed configuration to said ring-open configuration.

12. A mechanism according to claim 11 wherein said rings are adapted to remain in said ring-open configuration upon movement of said lever member from said third position to said first position.

13. A lever-arch type file mechanism including:
a base;
at least two rings secured to and extending upwardly from the base for engaging holes in at least a piece of paper, each said ring including a post member fixed to said base and an arch member movable relative to said post member; and
a lever assembly operable to move said arch members relative to said post members between a ring-closed configuration in which said rings are closed and a ring-open configuration in which said rings are open;
wherein said lever assembly includes a lever member and a first link member connected directly or indirectly with each other;
wherein said first link member carries a roller member movable on and along a crank portion joining said arch members; and
wherein said first link member is rotatable about an axis (D-D, M-M) from a first position to a second position to allow said rings to move from said ring-closed configuration to said ring-open configuration;
wherein said lever member is pivotable in a first direction to effect a force on a first point on said first link member between said axis and said base to move said first link member from said first position to said second position, and said lever member is pivotable in an opposite second direction to effect a force on a second point on said first link member which is away from said axis and said base to move said link member from said first position to said second position.

14. A mechanism according to claim 13 wherein said axis is fixed relative to said base.

15. A mechanism according to claim 13 wherein said lever member is connected with said first point of said first link member via a second link member.

16. A mechanism according to claim 15 wherein said lever member is pivotable towards said base to cause said second link member to effect a pulling force on said first point to move said first link member from said first position to said second position.

17. A mechanism according to claim 13 wherein said lever member is connected with said second point of said first link member via a third link member.

18. A mechanism according to claim 17 wherein said third link member is slidably movable relative to said first link member.

19. A mechanism according to claim 18 wherein said third link member has a slot with which a protrusion of said first link member is engaged for relative sliding movement.

20. A mechanism according to claim 17 wherein said lever member is pivotable away from said base to cause said third link member to effect a pushing force on said second point to move said first link member from said first position to said second position.

21. A lever-arch type file mechanism including:
a base;
at least two rings secured to and extending upwardly from the base for engaging holes in at least a piece of paper, each said ring including a post member fixed to said base and an arch member movable relative to said post member; and
a lever assembly operable to move said arch members relative to said post members between a ring-closed configuration in which said rings are closed and a ring-open configuration in which said rings are open;
wherein said lever assembly includes at least a lever member, a first link member and a second link member;
wherein said lever member carries said first link member, and said first link member is releasably engageable with said second link member.

22. A mechanism according to claim 21 wherein when said rings are in said ring-closed configuration, said first link member is out of engagement with said second link member.

23. A mechanism according to claim 21 wherein said lever member is pivotable in a first direction to bring said first link member into releasable engagement with said second link member to bring about simultaneous pivotal movement of said second link member through an angle to move said mechanism from said ring-closed configuration to said ring-open configuration.

24. A mechanism according to claim 23 wherein said lever member and said second link member are pivotable about a common axis (V-V).

25. A mechanism according to claim 24 wherein said common axis is fixed relative to said base.

26. A mechanism according to claim 23 wherein when said rings are in said ring-open configuration, said first link member is out of engagement with said second link member.

27. A mechanism according to claim 23 wherein said lever member has a curved edge which is slidable on said base upon further pivotal movement of said lever member in said first direction beyond said angle.

28. A mechanism according to claim 21 wherein said first link member is pivotally movable relative to said lever member between a first position and a second position.

29. A mechanism according to claim 28 wherein said first link member is spring-biased towards said first position.

30. A mechanism according to claim 21 wherein when said rings are in said ring-closed configuration, said first link member is in releasable engagement with said second link member.

31. A mechanism according to claim 30 wherein said first link member is pivotally movable relative to said lever member between a first position and a second position.

32. A mechanism according to claim 31 wherein said first link member is spring-biased towards said first position.

33. A mechanism according to claim 32 wherein said lever member includes a stopper for preventing pivotal movement of said first link member beyond said first position.

34. A paper retaining device including a lever-arch type file mechanism according to claim 1.

35. A paper retaining device according to claim 34 wherein said device includes a substrate to which said lever-arch type file mechanism is fixedly engaged.

36. A paper retaining device according to claim 35 wherein said device is a lever-arch type file.
